(19) United States
(12) Patent Application Publication
(10) Pub. No.: US 2009/0240004 A1
(43) Pub. Date: Sep. 24, 2009

(54) FUNCTIONALIZED POLYURETHANE RESIN, METHOD FOR THE PRODUCTION THEREOF, AND USE THEREOF

(76) Inventors: Alois Maier, Engelsberg (DE); Norbert Steidl, Kienberg (DE); Christian Huber, Trostberg (DE); Helmut Mack, Traunstein (DE); Johann Huber, Traunwalchen (DE); Thomas Schuhbeck, Trostberg (DE); Franz Wolfertetter, Palling (DE)

Correspondence Address: FULBRIGHT & JAWORSKI, LLP, 666 FIFTH AVE, NEW YORK, NY, 10103-3198, US

(21) Appl. No.: 12/441,589

(22) PCT Filed: Sep. 4, 2007
(86) PCT No.: PCT/EP2007/007693

§ 371 Date: Mar. 27, 2009

(30) Foreign Application Priority Data
Sep. 29, 2006 (DE) 10 2006 046 368.4

(51) Int. Cl. C08G 71/04

(52) U.S. Cl. 525/457

(57) ABSTRACT

Disclosed is a functionalized polyurethane resin containing a binder component, a hardener component and, optionally, a formulation component. The binder component consists essentially of urethane dispersions with defined structural components which, in turn, consist of special reaction products. Such polyurethane resins are used for the production of fluorine-modified polyurethane coatings and generally in construction or industrial applications for the permanent oil-, water- and dirt-resistant coating of mineral and non-mineral surfaces on the basis of, for example, hydraulically setting components.

The present invention relates to a functionalized polyurethane (PU) resin, to a process for preparing it, and to its use.

The majority of high-performance polymeric coating materials do have very good mechanical properties, but possess high surface energies. Through skillful chemical modification of these systems with fluorinated building blocks it is possible to unite the specific surface properties of fluorinated materials with the individual properties of the base polymers or copolymers. It proves advantageous in this context that often only small amounts of the expensive fluorine compounds are needed in order to achieve the desired surface properties.

The increasing demand for dirt-repelling and weathering-resistant coatings has led to the intense development of new fluoropolymers for coating systems that no longer have the disadvantages of conventional fluoropolymers. This new generation of fluorocarbon-based polymers for coating systems are soluble in common organic solvents, can be cured even at standard temperature, and exhibit improved compatibility with commercial curing agents.

Within coatings technology, increasing importance is being accorded to environmental considerations, including not least the observance of existing emissions guidelines. There is particular need in reducing the amounts of volatile organic solvents that are used in coating systems (VOC, volatile organic compounds).

The binder class of the aqueous or water-based polyurethanes, as an alternative to conventional solvent-based polyurethane systems, has been known for more than 40 years. The properties profile of the aqueous polyurethanes has been improved continuously in the decades that have elapsed, as documented by a multiplicity of patents and publications on this subject area. With regard to the chemistry and technology of the water-based polyurethanes, reference may be made to D. Dieterich, K. Uhlig in Ullmann's Encyclopedia of Industrial Chemistry, Sixth Edition 2001 Electronic Release. Wiley-VCH; D. Dieterich in Houben-Weyl, Methoden der Organischen Chemie. Vol. E20, H. Bartl, J. Falbe (Eds.), Georg Thieme Verlag, Stuttgart 1987, p. 1641ff.; D. Dieterich, Prog. Org. Coat. 9 (1981) 281-330; J. W. Rosthauser, K. Nachtkamp, Journal of Coated Fabrics 16 (1986) 39-79; R. Amoldus, Surf. Coat. 3 (Waterborne Coat.) (1990), 179 98.

Aqueous, low-cosolvent or extremely VOC-reduced, two-component polyurethane systems, which are of great importance in coating systems on account of their high level of properties, now constitute, in conjunction with water-emulsifiable polyisocyanate curing agent systems for chemical postcrosslinking, an alternative to the corresponding solventborne systems.

Water-based copolymer dispersions and emulsions based on perfluoroalkyl-containing monomers have been known for some time. They are used for imparting water and oil repellency, particularly to textiles and carpets, both alone and in conjunction with further textile auxiliaries, subject to the proviso that the perfluoroalkyl groups are linear and contain at least 6 carbon atoms.

A variety of emulsifier systems are used for preparing these copolymer dispersions and emulsions via emulsion polymerization, and the products, depending on the nature of the emulsifier system used, are anionically or cationically stabilized copolymer dispersions and emulsions having different performance properties.

Aqueous dispersions of graft copolymers containing perfluoroalkyl groups, and their use as water and oil repellents, have already been known from the patent literature for some time.

EP 0 452 774 A1 and DE 34 07 362 A1 describe a process for preparing aqueous dispersions of copolymers and/or graft copolymers of ethylenically unsaturated perfluoroalkyl monomers and non-fluorine-modified, ethylenically unsaturated monomers, the graft base used being aqueous, emulsifier-free polyurethane dispersions.

DE 36 07 773 C2 describes polyurethanes which contain perfluoroalkyl ligands and are used in the form of an aqueous dispersion, but using external emulsifiers, or in the form of a solution in an organic solvent (mixture), exclusively for the purpose of finishing textile materials and leather.

Polyurethanes which contain perfluoroalkyl groups and are intended for the oil and water repellency finishing of textiles are also described in patents DE 14 68 295 A1, DE 17 94 356 A1, DE 33 19 368 A1, EP 0 103 752 A1, U.S. Pat. No. 3,398,182 B1, U.S. Pat. No. 3,484,281 B1, and U.S. Pat. No. 3,896,251 B1. For application, however, these compounds request large amounts, and exhibit inadequate adhesion to the substrate.

WO 99/26 992 A1 describes aqueous, fluorine- and/or silicone-modified polyurethane systems with low surface energies that cure to give hard, water- and solvent-stable polyurethane films having antifouling properties. The claims there embrace the following two perfluoroalkyl components:

R_{f}—SO₂N—(Rₕ—OH)₂

(where R_{f}=perfluoroalkyl group having 1-20 C atoms and R_{b}=alkyl group having 1-20 C atoms) and

R_{f}R′_{f}CF—CO₂CH₂CR(CH₂OH)₂

where R_{f}═C₄-C₆ fluoroalkyl, R′_{f}═C₁-C₃ fluoroalkyl, and R═C₁-C₂ alkyl.

Water-dispersible sulfo-polyurethane or sulfo-polyurea compositions with low surface energy, especially for ink-receiving coatings, are described in EP 0 717 057 B1, the hydrophobic segments being composed of polysiloxane segments or of a saturated fluoroaliphatic group having 6 to 12 carbon atoms, of which at least 4 are fully fluorinated.

Aqueous dispersions of water-dispersible polyurethanes with perfluoroalkyl side chains, without the use of external emulsifiers, are described in EP 0 339 862 A1. The isocyanate-reactive component used there was a fluorinated polyol obtained by free radical addition of a polytetramethylene glycol with a fluorinated olefin (see EP 0 260 846 B1). Throughout, however, the resulting polyurethane dispersions possess solids contents of below 30% by weight and, moreover, require considerable amounts of hydrophilic component. The surface energies of the dried films are still always >30 dyne cm⁻¹.

European patent EP 1 478 707 B1 discloses an aqueous, fluorine-modified polyurethane system for antigraffiti and antisoiling coatings. The system it describes is based on an aqueous solution or dispersion of optionally hydroxyl- and/or amino-functional oligo- and/or polyurethanes with fluorinated side chains, as binder component, and optionally water-emulsifiable polyisocyanates as crosslinker component. These polyurethane resins are prepared in a six-stage process, making use, in particular, of components containing acid groups, polymeric polyol components, neutralizing components, and also chain extender and chain terminator components. The system described in this European patent is notable in particular for the fact that the through the fluorinated side groups present in the oligo- or polyurethane polymer, which are essentially responsible for the water repellency of the binder component, does not lead to an increase in the anionic hydrophilicization with salt groups. Moreover, even with very low fluorine contents, the cured films have significantly lowered surface energies. In both the formulated and unformulated states, aqueous, fluorine-modified one- or two-component polyurethane systems of this kind can be employed generally in the construction or industrial sectors as lightfast and chemical-resistant coating systems for the surfaces of mineral construction materials, producing a pronounced antigraffiti and antisoiling effect.

EP 1 136 278 A1 discloses polyurethane resins having fluorine side chains. The resin systems described there are very similar to the fluorine-modified polyurethanes described in the preceding instance. Significant differences exist, however, in that they do not include any components containing acid groups, any polymeric polyol components or any neutralizing chain extender and chain terminator components. Overall, the polyurethane resin described there is prepared in solution, with the fluorine content being 3% to 80% by weight, based on the polyurethane.

With regard in particular to the expanded opportunities for application of functionalized, and especially fluorine-modified, polyurethane resins, the present invention addressed the problem of providing a further functionalized polyurethane resin that has improved processing properties and in particular a further-improved properties profile with regard to the field of application for permanent oil-, water-, and dirt-repellent coatings on mineral and nonmineral surfaces. The new polyurethane resin system ought, furthermore, to possess good performance properties, and ought to be preparable with due regard to environmental, economic, and physiological aspects.

This problem has been solved in accordance with the invention by means of a corresponding functionalized polyurethane resin having the features according to claim 1 and comprising

100.0 to 100.1 parts by weight of a binder component (I), composed of fluorine-modified, anionically and/or nonionically and/or cationically stabilized oligourethane or polyurethane dispersions or solutions, having a polymer-bonded fluorine content of 0.01% to 10% by weight, a molecular mass of 10 000 to 1 000 000 daltons, and 0% to 25% by weight of free amino groups and/or 0% to 25% by weight of free hydroxyl groups, with the following synthesis components:

(i) 0.3 to 7.5 parts by weight of a fluorine-modified (polymeric) hydrophobicizing and oleophobicizing component (A) having a polymer-bonded fluorine content of 0.5% to 90% by weight, two or more amino and/or hydroxyl and/or mercapto groups that are reactive toward isocyanate groups, or two or more isocyanato groups that are reactive toward hydroxyl groups, and a molecular mass of 250 to 25 000 daltons, composed of

(1) reaction products, having two or more hydroxyl groups, of 5% to 95% by weight of a (per)fluoroalkyl alcohol component (A₁) and/or of a (per)fluoroalkylalkylenamine component (A₂), composed of perfluoroalkyl alcohols having terminal methylene groups (hydrocarbon spacers) of the general formula

CF₃—(CF₂)ₓ—(CH₂)_{y}—O-A_{z}-H

and/or

CR₃—(CR₂)ₓ—(CH₂)_{y}—O-A_{z}-H

in which R=independently of one another H, F, CF₃

and/or

hexafluoropropene oxide (HFPO) oligomer alcohols of the general formula

CF₃—CF₂—CF₂—[O—CF(CF₃)—CF₂]ₓ—O—CF(CF₃)—(CH₂)_{y}—O-A_{z}-H

in which x=3-20, y=1-6, z=0-100,

A=CRⁱRⁱⁱ—CRⁱⁱⁱR^{iv}—O or (CRⁱRⁱⁱ)ₐ—O or CO—(CRⁱRⁱⁱ)_{b}—O, Rⁱ, Rⁱⁱ, Rⁱⁱⁱ, R^{iv}, independently of one another H, alkyl, cycloalkyl, aryl, any organic radical having 1-25 C atoms; a, b=3-5, the polyalkylene oxide structural unit A_{z} comprising homopolymers, copolymers or block copolymers of any desired alkylene oxides, or comprising polyoxyalkylene glycols or comprising polylactones,

and/or a fluorine-modified macromonomer or telechelic component (A₃) having a polymer-bonded fluorine content of 1% to 99% by weight and a molecular mass of 100 to 10 000 daltons, comprising, terminally and/or laterally and/or intrachenally in the side chain and/or main chain, the structural elements

—CF₂—CF₂)ₓ—

and/or

—(CR₂—CR₂)ₓ—

and/or

—[CF₂—CF(CF₃)O]ₓ—

and/or

—(CR₂—CR₂—O)ₓ—

having in each case one or more reactive (cyclo)aliphatic and/or aromatic hydroxyl groups and/or primary and/or secondary amino groups and/or mercapto groups, 75% to 5% by weight of a difunctional polyisocyanate component (C₁) having two or more (cyclo)aliphatic and/or aromatic isocyanate groups of like or different reactivity, and 75% to 5% by weight of an amino alcohol component (A₄) having a (cyclo)aliphatic and/or aromatic, primary or secondary amino group and one or more (cyclo)aliphatic and/or aromatic hydroxyl groups, and/or of a mercapto alcohol component (A₅) having a (cyclo)aliphatic and/or aromatic mercapto group and one or more (cyclo)aliphatic and/or aromatic hydroxyl groups, the reaction in the case of diisocyanates having been carried out preferably in a molar ratio of 1:1:1 in any desired way, and the reaction products having the general formula

(A_{1/2/3})-(C₁)-(A_{4/5})

with (A_{1/2/3})=deprotonated components (A₁) and/or (A₂) and/or (A₃), (A_{4/5})=deprotonated components (A₄) and/or (A₅), and (C₁)=protonated component (C₁),

and/or

(2) reaction products, having two or more hydroxyl groups, of 5% to 95% by weight of a monofunctional hexafluoropropene oxide component (A₆), composed of monofunctional hexafluoropropene oxide oligomers of the general formula

CF₃—CF₂—CF—O—(CF(CF₃)—CF₂O)ₘ—CF(CF₃)—COR¹

in which m=1-20, R¹═F, OH, OMe, OEt

and 95% to 5% by weight of an amino alcohol component (A₄) and/or of a mercapto alcohol component (A₅), elimination of HR¹ having produced an adduct of the general formula

(A₆)-(A_{4/5})

in which (A₆)=carbonyl radical of component (A₆)

and the reaction having been carried out preferably in a molar ratio of 1:1 in any desired way,

and/or

(3) reaction products, having two or more hydroxyl groups, of 5% to 95% by weight of a difunctional hexafluoropropene oxide component (A₇), composed of difunctional hexafluoropropene oxide oligomers of the general formula

R¹OC—CF(CF₃)—(O—CF₂—CF(CF₃))ₙ—O—(CF₂)ₒ—O—

(CF(CF₃)—CF₂—O)ₙ—CF(CF₃)—COR¹

in which n=1-10, o=2-6

and 95% to 5% by weight of an amino alcohol component (A₄) and/or of a mercapto alcohol component (A₅), elimination of HR¹ having produced an adduct of the general formula

(A_{4/5})-(A₇)-(A_{4/5})

in which (A₇)=carbonyl radical of component (A₇)

and the reaction having been carried out preferably in a molar ratio of 1:2 in any desired way,

and/or

(4) reaction products, having two or more hydroxyl groups, of 5% to 95% by weight of a (per)fluoroalkyl alcohol component (A₁) and/or of a (per)fluoroalkylalkylenamine component (A₂) and/or of a fluorine-modified macromonomer or telechelic component (A₃), 75% to 5% by weight of a carbonyl component (A₈) of the general formula

X—CO—Y

in which X, Y═F, Cl, Br, I, CCl₃, R², OR², R²=alkyl, cycloalkyl, aryl, any organic radical having 1-25 C atoms, 0-10 N atoms, and 0-10 O atoms

and 75% to 5% by weight of an amino alcohol component (A₄) and/or of a mercapto alcohol component (A₅), elimination of HX and/or HY in the first stage having produced an adduct of the general formula

(A_{1/2/3})—CO—Y and/or X—CO-(A_{1/2/3})

and/or

(A_{4/5})—CO—Y and/or X—CO-(A_{4/5})

and elimination of HX and/or HY in the second stage having produced an adduct of the general formula

(A_{1/2/3})—CO-(A_{4/5})

and the reaction having been carried out preferably in a molar ratio of 1:1:1 in any desired way,

or

reaction products of 5% to 95% by weight of a pre-prepared adduct of the general formula

(A_{1/2/3})—CO—Y and/or X—CO-(A_{1/2/3})

and 95% to 5% by weight of an amino alcohol component (A₄) and/or of a mercapto alcohol component (A₅), elimination of HX and/or HY having produced an adduct of the general formula

(A_{1/2/3})—CO-(A_{4/5})

and the reaction having been carried out preferably in a molar ratio of 1:1 in any desired way,

or

reaction products of 5% to 95% by weight of a pre-prepared adduct of the general formula

(A_{4/5})—CO—Y and/or X—CO-(A_{4/5})

and 95% to 5% by weight of a (per)fluoroalkyl alcohol component (A₁) and/or of a (per)fluoroalkylalkylenamine component (A₂) and/or of a fluorine-modified macromonomer or telechelic component (A₃), elimination of HX and/or HY having produced an adduct of the general formula

(A_{1/2/3})—CO-(A_{4/5})

and the reaction having been carried out preferably in a molar ratio of 1:1 in any desired way,

and/or

(5) reaction products, having two or more hydroxyl groups, of 5% to 95% by weight of a (per)fluoroalkyl alcohol component (A₁) and/or of a (per)fluoroalkylalkylenamine component (A₂) and/or of a fluorine-modified macromonomer or telechelic component (A₃), 75% to 5% by weight of an amino alcohol component (A₄) and/or of a mercapto alcohol component (A₅), and 75% to 5% by weight of a polyisocyanate component (C₂) having a functionality of three or more, the reaction in the case of triisocyanates having been carried out preferably in a molar ratio of 2:1:1 or 1:2:1 in any desired way,

and/or

(6) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a mono functional polyalkylene glycol component (A₉) and/or of a monofunctional polyoxyalkylenamine component (A₁₀), composed of monohydroxy-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula

R³—O-A_{z}-H

in which z′=5-150, R³=alkyl, cycloalkyl, aryl, any organic radical having 1-25 C atoms

and/or

monoamino-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula

R³—O-A_{z′-1}-CRⁱRⁱⁱ—CRⁱⁱⁱR^{iv}NH₂

and 50% to 5% by weight of a polyisocyanate component (C₂) having a functionality of three or more, the reaction in the case of triisocyanates having been carried out preferably in a molar ratio of 1:1:1:1 in any desired way,

and/or

(7) reaction products, having two or more hydroxyl groups, of 5% to 95% by weight of a (per)fluoroalkyl alcohol component (A₁) and/or of a (per)fluoroalkylalkylenamine component (A₂) and/or of a fluorine-modified macromonomer or telechelic component (A₃), 75% to 5% by weight of an amino alcohol component (A₄) and/or of a mercapto alcohol component (A₅), and 75% to 5% by weight of a triazine component (A₁₁), composed of cyanuric chloride or 2,4,6-trichloro-1,3,5-triazine, the reaction having been carried out preferably in a molar ratio of 2:1:1 or 1:2:1 in any desired way,

and/or

(8) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a monofunctional polyalkylene glycol component (A₉) and/or of a monofunctional polyoxyalkylenamine component (A₁₀), and 50% to 5% by weight of a triazine component (A₁₁), composed of cyanuric chloride or 2,4,6-trichloro-1,3,5-triazine, the reaction having been carried out preferably in a molar ratio of 1:1:1:1 in any desired way,

and/or

(9) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a hydroxycarboxylic acid component (A₁₂), composed of a monohydroxycarboxylic acid and/or of a dihydroxycarboxylic acid having one and/or two polyisocyanate-reactive hydroxyl group(s) and a polyisocyanate-inert carboxyl group, and 50% to 5% by weight of a polyisocyanate component (C₂) having a functionality of three or more, the reaction in the case of triisocyanates having been carried out preferably in a molar ratio of 1:1:1:1 in any desired way,

and/or

(10) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of an NCN component (A₁₃), composed of cyanamide having a polyisocyanate-reactive and NH-acidic amino group, and 50% to 5% by weight of a polyisocyanate component (C₂) having a functionality of three or more, the reaction in the case of triisocyanates having been carried out preferably in a molar ratio of 1:1:1:1 in any desired way,

and/or

(11) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a hydroxycarboxylic acid component (A₁₂), composed of a monohydroxycarboxylic acid and/or of a dihydroxycarboxylic acid having one and/or two polyisocyanate-reactive hydroxyl group(s) and a polyisocyanate-inert carboxyl group, and 50% to 5% by weight of a triazine component (A₁₁), composed of cyanuric chloride or 2,4,6-trichloro-1,3,5-triazine, the reaction having been carried out preferably in the molar ratio of 1:1:1:1 in any desired way,

and/or

(12) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of an NCN component (A₁₂), composed of cyanamide having a polyisocyanate-reactive and NH-acidic amino group, and 50% to 5% by weight of a triazine component (A₁₁), composed of cyanuric chloride or 2,4,6-trichloro-1,3,5-triazine, the reaction having been carried out preferably in a molar ratio of 1:1:1:1 in any desired way,

and/or

(13) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a low molecular mass polyol component (B₁) and/or of a hydrophobically modified low molecular mass polyol component (B₂) of an anionically modifiable and/or cationically modifiable polyol component (B₃) and/or of a nonionically hydrophilic, polymeric polyol component (B₄) and/or of a high molecular mass (polymeric) polyol component (B₅), and 50% to 5% by weight of a difunctional polyisocyanate component (C₁), the reaction having been carried out preferably in a molar ratio of 1:1:1:2 in any desired way, and the reaction products having the general formula

(A_{1/2/3})-(C₁)—(B_{1/2/3/4/5})—(C₁)-(A_{4/5})

in which (B_{1/2/3/4/5})=deprotonated components (B₁) and/or (B₂) and/or (B₃) and/or (B₄) and/or (B₅),

and/or

(14) reaction products, having two or more hydroxyl groups, of 5% to 75% by weight of a (per)fluoroalkyl alcohol component (A₁) and/or of a (per)fluoroalkylalkylenamine component (A₂) and/or of a macromonomer or telechelic component (A₃), 50% to 5% by weight of an amino alcohol component (A₄) and/or of a mercapto alcohol component (A₅), 50% to 5% by weight of a polyfunctional polyalkylene glycol component (A₁₄) and/or of a polyfincfional polyoxyalkylenamine component (A₁₅), composed of polyhydroxy-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula

R⁴(—O-A_{z′}-H)_{z″}

in which z″=2-6, R⁴=alkyl, cycloalkyl, aryl, any organic radical having 1-25 C atoms

and/or

polyamino-funcfional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula

R⁴(—O-A_{z′-1}-CRⁱRⁱⁱ—CRⁱⁱⁱR^{iv}—NH₂)_{z″}

and 50% to 5% by weight of a difunctional polyisocyanate component (C₁), the reaction in the case of difunctional polyalkylene glycols and/or polyoxyalkylenamines having been carried out preferably in a molar ratio of 1:1:1:2 in any desired way, and the reaction products having the general formula

(A_{1/2/3})-(C₁)-(A_{14/15})-(C₁)-(A_{4/5})

in which (A_{14/15})=deprotonated components (A₁₄) and/or (A₁₅)

and/or

(15) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃) and/or of a hexafluoropropene oxide component (A₆) with R¹═OH and/or of a hexafluoropropene oxide component (A₇) with R¹═OH and/or of a (per)fluoroalkylalkanecarboxylic acid component (A₁₆) of the general formula

CF₃(CF₂)ₓ(CH₂)_{y}—COOH

and/or

CR₃(CR₂)ₓ—(CH₂)_{y}—COOH,

75% to 5% by weight of an amino alcohol component (A₄) and/or of a mercapto alcohol component (A₅) of a fatty alcohol component (A₁₇) having one or more hydroxyl groups, and/or of an (un)saturated fatty amine component (A₁₈) having one or more amino groups, and/or and/or of a fatty acid component (A₁₉) having one or more carboxyl groups, and 75% to 5% by weight of an epoxide component (A₂₀) having two or more epoxide groups, the reaction having been carried out preferably in a molar ratio of 1:1:1 in any desired way, and the reaction products having the general formula

(A_{1/2/3/6/7/16})-CH₂—CH(OH)—R⁵—CH(OH)—CH₂-(A_{4/5/17/18/19})

and/or

HO—CH₂—CH((A_{1/2/3/6/7/16}))—R⁵—CH((A_{4/5/17/18/19})—CH₂—OH

and/or

(A_{1/2/3/6/7/16})—CH₂—CH(OH)—R⁵—CH((A_{4/5/17/18/19})—CH₂—OH

and/or

HO—CH₂—CH((A_{1/2/3/6/7})—R⁵—CH(OH)CH₂-(A_{4/5/17/18/19})

in which (A_{1/2/3/6/7/16})=deprotonated components (A₆) and/or (A₇) and/or (A₁₆), (A_{4/5/17/18/19})=deprotonated components (A₁₇) and/or (A₁₈) and/or (A₁₉), R⁵=alkyl, cycloalkyl, aryl, any organic radical having 2-50 C atoms and 0-25 O atoms and 0-25 N atoms,

and/or

(16) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a polyisocyanate component (C₃) modified with uretdione groups, and 75% to 5% by weight of an amino alcohol component (A₄) and/or of a mercapto alcohol component (A₅), the reaction having been carried out preferably in a molar ratio of 2:1.2 in any desired way,

and/or

(17) reaction products, having two or more isocyanate groups, of 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a polyisocyanate component (C₂) having a functionality of three or more, the reaction having been carried out preferably in a molar ratio of 1:1 in any desired way,

and/or

(18) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of an amino alcohol component (A₄) and/or of a mercapto alcohol component (A₅), and 75% to 5% by weight of a polyisocyanate component (C₄) modified with sodium sulfonate groups, the reaction having been carried out preferably in a molar ratio of 1:1:1 in any desired way,

and/or

(19) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a monoisocyanate component (C₅) modified with unsaturated groups, and 75% to 5% by weight of an amino alcohol component (A₄) and/or of a mercapto alcohol component (A₅), the reaction having been carried out preferably in a molar ratio of 1:1:1 in any desired way,

and/or

(20) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a monoisocyanate component (C₆) modified with ester groups, and 75% to 5% by weight of an amino alcohol component (A₄) and/or of a mercapto alcohol component (A₅), the reaction having been carried out preferably in a molar ratio of 1:1:1 in any desired way,

and/or

(21) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a difunctional polyisocyanate component (C₁), 75% to 5% by weight of a hydroxy-functional (un)saturated triglyceride component (A₂₁) having two or more hydroxyl groups, the reaction having been carried out preferably in a molar ratio of 1:1:1 in any desired way,

and/or

(22) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a hydroxy- and epoxy-functional (un)saturated triglyceride component (A₂₂) having one or more hydroxyl groups and/or one or more epoxy groups, the reaction having been carried out preferably in a molar ratio of 1:1 in any desired way,

and/or

(23) reaction products, having two or more hydroxyl groups, of 5% to 95% by weight of a (per)fluoroalkylalkylene oxide component (A₂₃) of the general formula

CF₃—(CF₂)ₓ—(CH₂)_{y}—CHOCH₂

and/or

CR₃—(CR₂)ₓ—(CH₂)_{y}—CHOCH₂

and/or

CR₃—(CR₂)ₓ—(CH₂)_{y}—O—CH₂—CHOCH₂

and 95% to 5% by weight of an amino alcohol component (A₄) and/or of a mercapto alcohol component (A₅), the reaction having been carried out preferably in a molar ratio of 1:1 in any desired way,

and/or

(24) reaction products, having two or more hydroxyl groups, of 5% to 95% by weight of a (per)fluoroalkylalkylene oxide component (A₂₃) and 95% to 5% by weight of a chain extender or chain terminator component (E), the reaction in the case of monoamines with a primary amino group having been carried out preferably in a molar ratio of 2:1, in the case of diamines with two primary amino groups, preferably in a molar ratio of 4:1, in the case of diamines with a primary and a secondary amino group, preferably in a molar ratio of 3:1, and, in the case of diamines with a primary and a secondary amino group, preferably in a molar ratio of 2:1, in any desired way,

and/or

(25) reaction products, having two or more hydroxyl groups, of 5% to 95% by weight of a (per)fluoroalkylalkylene oxide component (A₂₃), 75% to 5% by weight of a difunctional polyisocyanate component (C₁), and 75% to 5% by weight of an amino alcohol component (A₄) and/or of a mercapto alcohol component (A₅), with oxazolidone structures having been formed, and the reaction having been carried out preferably in a molar ratio of 1:1:1 in any desired way,

and/or

(26) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a hydroxy-functional epoxide component (A₂₄) having one or more hydroxyl groups and/or one or more epoxy groups, and/or of a hydroxy-functional oxetane component (A₂₅) having one or more hydroxyl groups and/or one or more oxetane groups, the reaction having been carried out preferably in a molar ratio of 1:1 in any desired way,

and/or

(27) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a hydroxy-functional cyclopropane component (A₂₆) having one or more hydroxyl groups and/or one or more epoxy groups, and/or of a hydroxy-functional cyclobutane component (A₂₇) having one or more hydroxyl groups and/or one or more oxetane groups, the reaction having been carried out preferably in a molar ratio of 1:1 in any desired way,

and/or

(28) reaction products, having two or more hydroxyl groups, of 5% to 75% by weight of a (per)fluoroalkyl alcohol component (A₁) and/or of a (per)fluoroalkylalkylenamine component (A₂) and/or of a macromonomer or telechelic component (A₃), 50% to 5% by weight of a difunctional polyisocyanate component (C₁), 50% to 5% by weight of a hydroxy-functional lactone component (A₂₈), and 50% to 5% by weight of an amino alcohol component (A₄) and/or of a mercapto alcohol component (A₅), the reaction having been carried out preferably in a molar ratio of 1:1:1:1 in any desired way,

and/or

(29) reaction products, having two or more hydroxyl groups, of 5% to 95% by weight of a fluorine-modified (meth)acrylate component (A₂₉) and 95% to 5% by weight of an amino alcohol component (A₄) and/or of a mercapto alcohol component (A₅), the reaction having been carried out preferably in a molar ratio of 1:1 in any desired way,

and/or

(30) reaction products, having one or more primary and/or secondary amino groups and/or one or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a latent curing component (A₃₀) having a primary or secondary amino groups reactive toward isocyanate groups, or having a hydroxyl groups reactive toward isocyanate groups and having one or more hydroxyl groups and/or primary and/or secondary amino groups that are blocked and/or latently reactive toward isocyanate groups, and 75% to 5% by weight of water, first of all components (A₁) and/or (A₂) and/or (A₃) and (A₃₀) having been reacted in the first stage, the adduct from the first stage and the water having been reacted in the second stage, and any cleavage products liberated having been removed in the third stage, and the reaction having been carried out preferably in a molar ratio of 1:1:1 in any desired way,

and/or

(31) reaction products, having two or more hydroxyl groups, of 5% to 95% by weight of a (per)fluoroalkylalkylene isocyanate component (A₃₁) of the general formula

CF₃—(CF₂)ₓ—(CH₂)_{y}—NCO

and/or

CR₃—(CR₂)ₓ—(CH₂)_{y}—NCO

and 95% to 5% by weight of an amino alcohol component (A₄) and/or of a mercapto alcohol component (A₅), an adduct of the general formula

(A₃₁)-(A_{4/5})

in which (A₃₁)=protonated component (A₃₁)

having been obtained and the reaction having been carried out preferably in a molar ratio of 1:1 in any desired way,

and/or

(32) reaction products, having two or more hydroxyl groups, of 5% to 95% by weight of a (per)fluoroalkylalkanecarboxylic acid derivative component (A₃₂) of the general formula

CF₃—(CF₂)ₓ—(CH₂)_{y}—COR⁶

and/or

CR₃—(CR₂)ₓ—(CH₂)_{y}COR⁶

with R⁶=Cl, OMe, OEt

and 95% to 5% by weight of an amino alcohol component (A₄) and/or of a mercapto alcohol component (A₅), elimination of HR⁶ having produced an adduct of the general formula

(A₃₂)-(A_{4/5})

in which (A₃₂)=carbonyl radical of component (A₃₂)

and the reaction having been carried out preferably in a molar ratio of 1:1 in any desired way,

and/or (33) reaction products according to variants (1), (5), (6), (9), (10), (13), (14), (16)-(22), the (per)fluoroalkyl alcohol component (A₁) and/or the (per)fluoroalkylalkylenamine component (A₂) and/or the macromonomer or telechelic component (A₃) having been replaced by the (per)fluoroalkylalkanecarboxylic acid component (A₃₂), and amide structures having been obtained, with elimination of CO₂,

and/or

(34) alkoxylated reaction products according to variants (1) to (16) and (18) to (33) having two or more hydroxyl groups, the alkoxylated reaction products having the general formula

(U)-(A_{z′}-H)_{z″}

in which (U)=deprotonated reaction products (1) to (16) and (18) to (33),

and/or

(35) a polyhedral oligomeric polysilasesquioxane component (A₃₃) having one or more amino and/or hydroxyl and/or isocyanato and/or mercapto groups and one or more perfluoroalkyl groups of the general formula

(R⁷ᵤR⁸ᵥR⁹_{w}SiO_{1.5})ₚ

in which 0<u<1, 0<v<1, 0<w<1,u+v+w=1, p=4, 6, 8, 10, 12, and R⁷, R⁸, R⁹=independently of one another any inorganic and/or organic and optionally polymeric radical having 1-250 C atoms and 1-50 N and/or 0-50 O and/or 3-100 F and/or 0-50 Si and/or 0-50 S atoms,

(ii) 0.1 to 2.5 parts by weight of at least one low molecular mass polyol component (B₁) having two or more hydroxyl groups that are reactive toward isocyanate groups, and having a molecular mass of 62 to 499 daltons,

(iii) 0 to 2.5 parts by weight of at least one hydrophobically modified low molecular mass polyol component (B₂) having two or more hydroxyl groups that are reactive toward isocyanate groups, and having a molecular mass of 118 to 750 daltons, comprising, in the main chain and/or side chain, the structural elements

—(CH₂)ₖ— with k≧8,

(iv) 0 to 2.5 parts by weight of at least one anionically modifiable and/or cationically modifiable polyol component (B₃) having one or more inert carboxylic and/or phosphonic and/or sulfonic acid groups, which by means of bases can be converted partly or fully into carboxylate and/or phosphonate and/or sulfonate groups or are already present in the form of carboxylate and/or phosphonate and/or sulfonate groups, and/or having one or more tertiary amino groups, which by means of acids can be converted into ammonium groups or are already present in the form of ammonium groups, and having two or more hydroxyl groups that are reactive toward isocyanate groups, and a molecular mass of 104 to 499 daltons,

(v) 0.1 to 2.5 parts by weight of at least one nonionically hydrophilic polymeric polyol component (B₄) having two or more hydroxyl groups that are reactive toward isocyanate groups, and a molecular mass of 500 to 5000 daltons,

(vi) 1.0 to 25.0 parts by weight of at least one high molecular mass (polymeric) polyol component (B₅) having one or more hydroxyl groups that are reactive toward isocyanate groups, and a molecular mass of 500 to 10 000 daltons,

(vii) 1.0 to 25.0 parts by weight of at least one polyisocyanate component (C), composed of a polyisocyanate and/or polyisocyanate derivative and/or polyisocyanate homologs having two or more reactive (cyclo)aliphatic and/or aromatic isocyanate groups and a molecular mass of 100 to 5000 daltons,

(viii) 0.1 to 2.5 parts by weight of at least one neutralizing component (D), composed of an inorganic and/or organic base and/or acid,

(ix) 0.1 to 2.5 parts by weight of at least one (polymeric) chain extender and/or chain terminator component (E) having one or more primary and/or secondary (cyclo)aliphatic and/or aromatic amino groups that are reactive toward isocyanate groups, and/or having one or more hydroxyl groups that are reactive toward isocyanate groups, and a molecular mass of 60 to 5000 daltons,

(x) 0 to 2.5 parts by weight of at least one reactive nanoparticle component (F), composed of inorganic and/or organic nanoparticles or nanocomposites in the form of primary particles and/or aggregates and/or agglomerates, the nanoparticles being optionally hydrophobicized and/or doped and/or coated and surface-modified with reactive amino and/or hydroxyl and/or mercapto and/or isocyanato and/or epoxy and/or methacryloyl and/or silane groups of the general formula —Si(OR¹)_{3-x′}R²_{x′},

(xi) 0 to 10.0 parts by weight of at least one solvent component (G), composed of a high-boiling and/or low-boiling organic solvent,

(xii) 0 to 0.1 part by weight of at least one catalyst component (H),

(xiii) 97.3 to 100.0 parts by weight of water (I),

0 to 50 parts by weight of at least one curing component (II), composed of a polyisocyanate and/or polyisocyanate derivative and/or polyisocyanate homolog having two or more reactive (cyclo)aliphatic and/or aromatic isocyanate groups or a carbodiimide crosslinker and a molecular mass of 100 to 5000 daltons, and

0 to 300.0 parts by weight of a formulating component (III).

The new polyurethane resin is distinguished essentially by the included binder component (I) and also the curing component (II). Provision is made here for the binder component (I) to be based on a combination of synthesis components (i) to (xiii), the synthesis component (i) comprising reaction products which lead to the hydrophobicizing and oleophobicizing component (A). The further synthesis components of which account is taken comprise at least one polyol component (B₁ to B₅), a polyisocyanate (C), the neutralizing component (D), the chain extender component (E), a nanoparticle component (F), a solvent component (G), a catalyst component (H), and water. At this point it is noted that each of the formulae given represent idealized depictions which most closely approximate to the actual circumstances within the polyurethane resin claimed.

It has surprisingly emerged in practice that the new functionalized polyurethane resin is notable for an improved, and in particular more homogeneous, side-chain distribution, which is manifested directly in improved economics in respect of the fields of application in question. Moreover, during the preparation of dispersions, the byproducts are significantly fewer, and the polyurethane resins of the invention have improved compatibility more particularly in the case where mixtures are produced. Many of the stated positive effects occur more particularly in connection with the optional, hydrophobically modified and low molecular mass polyol component (B₂). Overall, the new polyurethane resin system scores over the prior art in further-improved properties, which could not have been expected to be so on the basis of the diversity of existing, and especially fluorine-modified polyurethane resins.

As suitable (per)fluoroalkyl alcohol component (A₁) it is possible to use, for example, 3,3,4,4,5,5,6,6,7,7,8,8,8-tridecafluorooctan-1-ol, 3,3,4,4,5,5,6,6,7,7,8,8,9,9,10,10,10-heptadecafluorodecan-1-ol, 3,3,4,4,5,5,6,6,7,7,8,8,9,9,10,10,11,11,12,12,12-heneicosafluorododecan-1-ol, 3,3,4,4,5,5,6,6,7,7,8,8,9,9,10,10,11,11,12,12,13,13,14,14,14-pentacosafluorotetradecan-1-ol, 3,3,4,4,5,5,6,6,7,7,8,8,9,9,10,10,11,11,12,12,13,13,14,14,15,15,16,16,16-nonacosafluorohexadecan-1-ol, 3,3,4,4,5,5,6,6,7,7,8,8-dodecafluoroheptan-1-ol, 3,3,4,4,5,5,6,6,7,7,8,8,9,9,10,10-hexadecafluorononan-1-ol, 3,3,4,4,5,5,6,6,7,7,8,8,9,9,10,10,11,11,12,12-eicosafluoroundecan-1-ol, 3,3,4,4,5,5,6,6,7,7,8,8,9,9,10,10,11,11,12,12,13,13,14,14-tetracosafluorotridecan-1-ol, 3,3,4,4,5,5,6,6,7,7,8,8,9,9,10,10,11,11,12,12,13,13,14,14,15,15,16,16-octacosafluoropentadecan-1-ol, the commercial products Fluowet® EA 600, Fluowet® EA 800, Fluowet® EA 093, Fluowet® EA 612, Fluowet® EA 612 N, Fluowet® EA 812 AC, Fluowet® EA 812 IW, Fluowet® EA 812 EP, Fluowet® EA 6/1020, Fluowet® PA, consisting of perfluoroalkylethanol mixtures, Fluowet® OTL, Fluowet® OTN, consisting of ethoxylated perfluoroalkylethanol mixtures, from Clariant GmbH, the commercial products A-1620, A-1630, A-1660, A-1820, A-1830, A-1860, A-2020, A-3620, A-3820, A-5610, A-5810 from Daikin Industries, Ltd., the commercial products Zonyle BA, Zonyl® BA L, Zonylo BA LD, Foralkyl® EOH-6N LW, consisting of perfluoroalkylethanol mixtures, Zonyl® OTL, Zonyle OTN, consisting of ethoxylated perfluoroalkylethanol mixtures, Zonyl® FSH, Zonyl® FSO, Zonyl® FSN, Zonyl® FS-300, Zonyl® FSN-100, Zonyl® FSO-100 from Du Pont de Nemours, the commercial products Krytox® from Du Pont de Nemours, consisting of hexafluoropropene oxide (HFPO) oligomer/alcohol mixtures, or suitable combinations thereof. It is preferred to use perfluoroalkylethanol mixtures with 30%-49.9% by weight of 3,3,4,4,5,5,6,6,7,7,8,8,8-tridecafluorooctan-1-ol and 30%-49.9% by weight of 3,3,4,4,5,5,6,6,7,7,8,8,9,9,10,10,10-heptadecafluorodecan-1-ol such as the commercial products Fluowet® EA 612 and Fluowet® EA 812. Also suitable are the commercial products A-1620 and A-1820 from Daikin Industries, Ltd.

As suitable (per)fluoroalkylalkylenamine component (A₂) it is possible to use, for example,

3,3,4,4,5,5,6,6,7,7,8,8,8-tridecafluorooctylamine, 3,3,4,4,5,5,6,6,7,7,8,8,9,9,10,10,10-heptadecafluorodecylamine, 3,3,4,4,5,5,6,6,7,7,8,8,9,9,10,10,11,11,12,12,12-heneicosafluorododecylamine, 3,3,4,4,5,5,6,6,7,7,8,8,9,9,10,10,11,11,12,12,13,13,14,14,14-pentacosafluorotetradecylamine, 3,3,4,4,5,5,6,6,7,7,8,8,9,9,10,10,11,11,12,12,13,13,14,14,15,15,16,16,16-nonacosafluorohexadecylamine, reaction products of 1,1,1,2,2,3,3,4,4,5,5,6,6-tridecafluoro-8-iodoctane, 1,1,1,2,2,3,3,4,4,5,5,6,6,7,7,8,8-heptadecafluoro-10-iododecane, 1,1,1,2,2,3,3,4,4,5,5,6,6,7,7,8,8,9,9,10,10-heneicosafluoro-12-iodododecane, 1,1,1,2,2,3,3,4,4,5,5,6,6,7,7,8,8,9,9,10,10,11,11,12,12-pentacosafluoro-14-iodotetradecane, 1,1,1,2,2,3,3,4,4,5,5,6,6,7,7,8,8,9,9,10,10,11,11,12,12,13,13,14,14-nonacosafluoro-16-iodohexadecane, the commercial products Fluowet® I 600, Fluowet® I 800, Fluowet® I 612, Fluowet® I 812, Fluowet® I 6/1020, Fluowet® I 1020, consisting of perfluoroalkyl iodide mixtures, Fluowet® EI 600, Fluowet® EI 800, Fluowet® EI 812, Fluowet® EI 6/1020, consisting of perfluoroalkylethyl iodide mixtures, from Clariant GmbH, and suitable aminating reagents, the commercial products U-1610, U-1710, U-1810 from Daikin Industries, Ltd., or suitable combinations thereof. Preference is given to perfluoroalkylethanol mixtures with 30%-49.9% by weight of 3,3,4,4,5,5,6,6,7,7,8,8,8-tridecafluorooctylamine and 30%-49.9% by weight of 3,3,4,4,5,5,6,6,7,7,8,8,9,9,10,10,10-heptadecafluorodecylamine.

Suitability for use as fluorine-modified macromonomer or telechelic component (A₃) is possessed, for example, by 4-(3,3,4,4,5,5,6,6,7,7,8,8,8-tridecafluorooctyl)benzyl alcohol, 4-(3,3,4,4,5,5,6,6,7,7,8,8,9,9,10,10,10-heptadecafluorodecyl)benzyl alcohol, 4-(3,3,4,4,5,5,6,6,7,7,8,8,8-tridecafluorooctylthio)phenol, 4-(3,3,4,4,5,5,6,6,7,7,8,8,9,9,10,10,10-heptadecafluorodecylthio)phenol, 4-(4,4,5,5,6,6,7,7,8,8,9,9,9-tridecafluorononyloxy)benzyl alcohol, 4-(4,4,5,5,6,6,7,7,8,8,9,9,10,10,11,11,11-heptadecafluoroundecyloxy)benzyl alcohol, 4-(3,3,4,4,5,5,6,6,7,7,8,8,8-tridecafluorooctyl)benzylamine, 4-(3,3,4,4,5,5,6,6,7,7,8,8,9,9,10,10,10-heptadecafluorodecyl)benzylamine, 3,3,4,4,5,5,6,6,7,7,8,8,8-tridecafluorooctane-1-thiol, 3,3,4,4,5,5,6,6,7,7,8,8,9,9,10,10,10-heptadecafluorodecane-1-thiol, 3,3,4,4,5,5,6,6,7,7,8,8,9,9,10,10,11,11,12,12,12-heneicosafluorododecane-1-thiol, 3,3,4,4,5,5,6,6,7,7,8,8,9,9,10,10,11,11,12,12,13,13,14,14,14-pentacosafluorotetradecane-1-thiol, 3,3,4,4,5,5,6,6,7,7,8,8,9,9,10,10,11,11,12,12,13,13,14,14,15,15,16,16,16-nonacosafluorohexadecane-1-thiol, hydroxy-functional copolymers based on tetrafluoroethylene and hydroxyalkyl(meth)acrylates such as the commercial products Zeffle® GK-500, GK-510, GK 550 from Daikin Industries, Ltd., or suitable combinations thereof.

In accordance with the invention a polyurethane resin is preferred which is based on ethanolamine and/or N-methylethanolamine and/or diethanolamine and/or diisopropanolamine as component (A₄). Suitability is also possessed, however, by 3-((2-hydroxyethyl)amino)-1-propanol, tris(hydroxymethyl)aminomethane or trimethylolmethylamine, 2(3)(4)-piperidinemethanol, amino sugars such as galactosamine, glucamine, glucosamine, neuramic acid or suitable combinations thereof.

Examples of suitable mercapto alcohol component (A₅) include 2-mercaptoethanol, 3-mercapto-1-propanol, 1-mercapto-2-propanol, 4-mercapto-1-butanol, 4-mercapto-2-butanol, thioglycerol, 2-mercaptoethylamine or suitable combinations thereof, with 2-mercaptoethanol and/or thioglycerol being preferred synthesis components (A₅).

Monofunctional polyhexafluoropropene oxide carboxylic acids, polyhexafluoropropene oxide carboxylic fluorides, polyhexafluoropropene oxide carboxylic acid methyl esters from Dyneon GmbH & Co. KG or suitable combinations thereof represent suitable monofunctional hexafluoropropene oxide component (A₆).

With regard to the difunctional hexafluoropropene oxide component (A₇), the PU resin may be based, for example, on difunctional polyhexafluoropropene oxide carboxylic acids, polyhexafluoropropene oxide carboxylic acid fluorides, polyhexafluoropropene oxide carboxylic acid methyl esters from Dyneon GmbH & Co. KG or suitable combinations thereof.

Examples of suitable carbonyl component (A₈) include phosgene, diphosgene, triphosgene, aliphatic and/or aromatic chloroformates such as methyl chloroformate, ethyl chloroformate, isopropyl chloroformate, phenyl chloroformate, aliphatic and/or aromatic carbonic esters such as dimethyl carbonate, diethyl carbonate, diisopropyl carbonate, diphenyl carbonate or a suitable combination thereof, with preference being given to phosgene, ethyl chloroformate, and diethyl carbonate. As a suitable carbonyl component (A₈) it is possible additionally to use, for example, pre-prepared adducts of component (A₈) and components (A₁) and/or (A₂) and/or (A₃), or pre-prepared adducts of component (A₈) and components (A₄) and/or (A₅), or suitable combinations thereof. Use should in particular be made of chloroformates and/or phosgene derivatives of components (A₁) and/or (A₂) and/or (A₃).

Examples of suitable monofunctional polyalkylene glycol component (A₉) include the commercial products M 250, M 350, M 350 PU, M 500, M 500 PU, M 750, M 1100, M 2000 S, M 2000 FL, M 5000 S, M 5000 FL, consisting of monofunctional methyl-polyethylene glycol, B11/50, B11/70, B11/100, B 11/150, B11/150 K, B11/300, B11/700, consisting of monofunctional butyl-poly(ethylene oxide-ran-propylene oxide), from Clariant GmbH, the commercial product LA-B 729, consisting of monofunctional methyl-poly(ethylene oxide-block/co-propylene oxide) from Degussa AG, or suitable combinations thereof.

As a monofunctional polyoxyalkylenamine component (A₁₀) it is possible to make use, for example, of the commercial products JEFFAMINE® XTJ-505 (M-600), JEFFAMINE® XTJ-506 (M-1000), JEFFAMINE® XTJ-507 (M-2005), JEFFAMINE® M-2070, consisting of monofunctional polyoxyalkylenamine based on ethylene oxide and propylene oxide, from Huntsman Corporation, or suitable combinations thereof.

Cyanuric chloride or 2,4,6-trichloro-1,3,5-triazine from Degussa AG, or other 1,3,5-triazines with a suitable substitution pattern and sufficient reactivity, or suitable combinations thereof, are suitable as triazine component (A₁₁).

Suitability as hydroxycarboxylic acid component (A₁₂) for the PU resin of the invention is possessed by, for example, 2-hydroxymethyl-3-hydroxypropanoic acid or dimethylolacetic acid, 2-hydroxymethyl-2-methyl-3-hydroxypropanoic acid or dimethylolpropionic acid (DMPA), 2-hydroxymethyl-2-ethyl-3-hydroxypropanoic acid or dimethylolbutyric acid, 2-hydroxymethyl-2-propyl-3-hydroxypropanoic acid or dimethylolvaleric acid, hydroxypivalic acid (HPA), citric acid, tartaric acid or suitable combinations thereof. If necessary it is also possible to use amino-functional and optionally hydro-functional carboxylic acids such as 2-hydroxyethanoic acid or amino- and/or hydrofunctional sulfonic acids such as 2-aminoethanoic acid, tris(hydroxymethyl)methyl-3-aminopropanesulfonic acid or suitable combinations thereof.

As NCN component (A₁₃) it is possible for example to employ cyanamide or carbamonitrile from Degussa AG or other NCN compounds having a suitable substitution pattern and sufficient NH acidity, or suitable combinations thereof.

Suitable polyfunctional polyalkylene glycol component (A₁₄) is represented in the context of the present invention by, for example, the commercial products 200, 200 G, 300, 300 G, 400, 400 G, 600, 600 A, 600 PU, 900, 1000, 1000 WA, 1500 S, 1500 FL, 1500 PS, 2000 S, 2000 FL, 3000 S, 3000 P, 3000 FL, 3350 S, 3350 P, 3350 FL, 3350 PS, 3350 PT, 4000 S, 4000 P, 4000 FL, 4000 PS, 4000 PF, 5000 FL, 6000 S, 6000 P, 6000 PS, 6000 FL, 6000 PF, 8000 S, 8000 P, 8000 FL, 8000 PF, 10000 S, 10000 P, 12000 S, 12000 P, 20000 S, 20000 P, 20000 SR, 20000 SRU, 35000 S, consisting of difunctional polyethylene glycol, PR 300, PR 450, PR 600, PR 1000, PR 1000 PU, VPO 1962, consisting of difunctional poly(ethylene oxide-block-propylene oxide-block-ethylene oxide), D21/150, D21/300, D21/700, consisting of difunctional poly(ethylene oxide-ran-propylene oxide), P41/200 K, P41/300, P41/3000, P41/120000, consisting of tetrafunctional poly(ethylene oxide-ran-propylene oxide), from Clariant GmbH or suitable combinations thereof.

As suitable polyfunctional polyoxyalkylenamine component (A₁₅) it is possible for example to use the commercial product JEFFAMINE® HK-511 (XTJ-511), JEFFAMINE4 XTJ-500 (ED-600), JEFFAMINE® XTJ-502 (ED-2003), consisting of difunctional polyoxyalkylenamine based on ethylene oxide and propylene oxide, from Huntsman Corporation, or suitable combinations thereof.

Suitability for the present PU resin is possessed for example by tridecafluoroheptanoic acid, pentadecafluorooctanoic acid, heptadecafluorononanoic acid, nonadecafluorodecanoic acid, heneicosafluoroundecanoic acid, the commercial products C-1600, C-1700, C-1800, C-1900, C-2000, C-5600, C-5800 from Daikin Industries, Ltd., or suitable combinations thereof, as (per)fluoroalkylalkanecarboxylic acid component (A₁₆).

A typical (un)saturated fatty alcohol component (A₁₇) is represented, for example, by saturated fatty alcohols such as hexan-1-ol or caproyl alcohol, heptan-1-ol or enanthyl alcohol, octan-1-ol or caprylyl alcohol, nonan-1-ol or pelargyl alcohol, decan-1-ol or capryl alcohol, undecan-1-ol, dodecan-1-ol or lauryl alcohol, tridecan-1-ol, tetradecan-1-ol or myristyl alcohol, pentadecan-1-ol, hexadecan-1-ol or cetyl alcohol, heptadecan-1-ol or margaryl alcohol, octadecan-1-ol or stearyl alcohol, nonadecan-1-ol, eicosan-1-ol or arachidyl alcohol, heneicosan-1-ol, docosan-1-ol or behenyl alcohol, tricosan-1-ol, tetracosan-1-ol or lignoceryl alcohol, pentacosan-1-ol, hexacosan-1-ol or ceryl alcohol, heptacosan-1-ol, 1-octacosan-1-ol or montanyl alcohol, nonacosan-1-ol, triacontan-1-ol or myricyl alcohol, hentriacontan-1-ol or melissyl alcohol, dotriacontan-1-ol or lacceryl alcohol, tritriacontan-1-ol, tetratriacontan-1-ol or geddyl alcohol, saturated Guerbet alcohols such as 2-methylpentan-1-ol, 2-ethylhexan-1-ol, 2-propylheptan-1-ol, 2-butyloctan-1-ol, 2-pentylnonan-1-ol, 2-hexyldecan-1-ol, 2-heptylundecan-1-ol, 2-octyldodecan-1-ol, 2-nonyltridecan-1-ol, 2-decyltetradecan-1-ol, 2-undecylpentadecan-1-ol, 2-dodecylhexadecan-1-ol, 2-tridecylheptadecan-1-ol, 2-tetradecyloctadecan-1-ol, 2-pentadecylnonadecan-1-ol, 2-hexadecyleicosan-1-ol, 2-heptadecylheneicosan-1-ol, 2-octadecyldocosan-1-ol, 2-nonadecyltricosan-1-ol, 2-eicosyltetracosan-1-ol, unsaturated fatty alcohols such as 10-undecen-1-ol, Z-9-octadecen-1-ol or oleyl alcohol, E-9-octadecen-1-ol or elaidyl alcohol, Z,Z-9,12-octadecadien-1-ol or linoleyl alcohol, Z,Z,Z-9,12,15-octadecatrien-1-ol or linolenyl alcohol, Z-13-docosen-1-ol or erucyl alcohol, E-13-docosen-1-ol or brassidyl alcohol or suitable combinations thereof.

With regard to the fatty amine component (A₁₈) it is possible to employ, for example, saturated primary amines such as octylamine, decylamine, dodecylamine, tetradecylamine, hexadecylamine, octadecylamine, eicosylamine, docosylamine, saturated secondary amines such as dioctylamine, didecylamine, didodecylamine, ditetradecylamine, dihexadecylanine, dioctadecylamine or suitable combinations thereof.

As fatty acid component (Al₉) the claimed PU resin may comprise, for example, saturated fatty acids such as hexanoic acid or caproic acid, heptanoic acid or enanthic acid, octanoic acid or caprylic acid, nonanoic acid or pelargonic acid, decanoic acid or capric acid, undecanoic acid, dodecanoic acid or lauric acid, tridecanoic acid, tetradecanoic acid or myristic acid, pentadecanoic acid, hexadecanoic acid or palmitic acid, heptadecanoic acid or margaric acid, octadecanoic acid or stearic acid, nonadecanoic acid, eicosanoic acid or arachidic acid, docosanoic acid or behenic acid, tetracosanoic acid or lignoceric acid, hexacosanoic acid or cerotinic acid, octacosanoic acid or montanic acid, triacontanoic acid or melissic acid, unsaturated fatty acids such as 10-undecenoic acid, Z-9-tetradecenoic acid or myristoleic acid, Z-9-hexadecenoic acid or palmitoleic acid, Z-6-octadecenoic acid or petroselinic acid, E-6-octadecenoic acid or petroselaidic acid, Z-9-octadecenoic acid or oleic acid, E-9-octadecenoic acid or elaidic acid, Z,Z-9,12-octadecadienoic acid or linoleic acid, E,E-9,12-octadecadienoic acid or linolaidic acid, Z,Z,Z-9,12,15-octadecatrienoic acid or linolenic acid, E,E,E-9,12,15-octadecatrienoic acid or linolenelaidic acid, Z,E,E-9,11,13-octadecatrienoic acid or β-eleostearic acid, E,E,E-9,11,13-octadecatrienoic acid or β-eleostearic acid, Z-9-eicosenoic acid or gadoleic acid, 5,8,11,14-eicosatetraenoic acid or arachidonic acid, Z-13-docosenoic acid or erucic acid, E-13-docosenoic acid or brassidic acid, 4,8,12,15,19-docosapentaenoic acid or clupanodonic acid, (refined) fatty acid mixtures based on triglycerides, or suitable combinations thereof.

Examples of suitable epoxide component (A₂₀) include, for example, bisphenol A diglycidyl ether and its higher homologs and isomers, bisphenol F diglycidyl ether and its higher homologs and isomers, hydrogenated bisphenol A diglycidyl ethers and their higher homologs and isomers, hydrogenated bisphenol F diglycidyl ethers and their higher homologs and isomers, cresol-novolak glycidyl ethers, phenol novolak glycidyl ethers, butane-1,4-diol diglycidyl ether, 1,4-cyclohexanedimethanol diglycidyl ether, ethylene glycol diglycidyl ether, glycerol triglycidyl ether, hexane-1,6-diol diglycidyl ether, neopentyl glycol diglycidyl ether, pentaerythritol tetraglycidyl ether, polyethylene glycol diglycidyl ether, polypropylene glycol diglycidyl ether, polyalkylene glycol diglycidyl ethers, triglycidyl isocyanurate, trimethylolpropane diglycidyl ether, the commercial products Polypox® E 064, E 150, E 152, E 221, E 227, E 237, E 253, E 254, E 260, E 270, E 270/700, E 270/500, E 280, E 280/700, E 280/500, E 375, E 395, E 403, E 411, E 442, E 492, E 630 (epoxy resins (solvent-free)), E 2400/75, E 2401.80, E 1001×75 (epoxy resins (solvent-containing)), E 260 W, E 2500/60 W (epoxy resins (for aqueous systems)), R 3, R 6, R 7, R 9, R 11, R 12, R 14, R 16, R 17, R 18, R 19, R 20, R 24 (glycidyl ethers) from UPPC AG, or suitable combinations thereof.

Suitable (un)saturated triglyceride components (A₂₁) are, for example, mono- and/or di- and/or triesters of glycerol and (un)saturated and optionally hydroxy-functional fatty acids having 1 to 30 carbon atoms, (partially) epoxidized and ring-opened mono- and/or di- and/or triesters of glycerol and unsaturated and optionally hydroxy-functional fatty acids having 1 to 30 carbon atoms, or suitable combinations thereof. As a suitable fatty acid basis it is possible to make use for example of component (A₁₇), tung oil, linseed oil, ricinene oil, tall oil, safflower oil, grapeseed oil, sunflower oil, soybean oil, peanut oil, castor oil, olive oil, coconut oil or suitable combinations thereof.

Also suitable as hydroxy- and epoxy-functional (un)saturated triglyceride component (A₂₂) are, for example, epoxidized and partially ring-opened mono- and/or di- and/or triesters of glycerol and unsaturated and optionally hydroxy-functional fatty acids or suitable combinations thereof. A suitable fatty acid basis is provided, for example, by component (A₁₇), tung oil, linseed oil, ricinene oil, tall oil, safflower oil, grapeseed oil, sunflower oil, soybean oil, peanut oil, castor oil, olive oil, coconut oil, the commercial products Edenol® D 81, Edenol® D 82, Edenol® B 316, Edenol® B 35 from Cognis Deutschland GmbH & Co. KG, or suitable combinations thereof.

Typical representatives of (per)fluoroalkylalkylene oxide component (A₂₃) are, for example, 4,4,5,5,6,6,7,7,8,8,9,9,9-tridecafluorononene 1,2-oxide, 4,4,5,5,6,6,7,7,8,8,9,9,10,10,11,11,11-heptadecafluoroundecene 1,2-oxide, 4,4,5,5,6,6,7,7,8,8,9,9,10,10,11,11,12,12,13,13,13-heneicosafluorotridecene 1,2-oxide, glycidyl 2,2,3,3,4,4,5,5,6,6,7,7-dodecafluoroheptyl ether, glycidyl 2,2,3,3,4,4,5,5,6,6,7,7,8,8,9,9-hexadecafluorononyl ether, glycidyl 2,2,3,3,4,4,5,5,6,6,7,7,8,8,9,9,10,10,11,11-eicosafluoroundecyl ether, the commercial products E-1830, E-2030, E-3630, E-3830, E-5644, E-5844 from Daikin Industries, Ltd., or suitable combinations thereof.

Glycidol, glycerol glycidyl ether, glycerol diglycidyl ether, (cyclo)aliphatic and/or aromatic polyols partly etherified with epichlorohydrin, or suitable combinations thereof are suitable as hydroxy-functional epoxide component (A₂₄).

Suitability for hydroxy-functional oxetane component (A₂₅) is possessed for example by 3-ethyl-3-oxetanemethanol or trimethylolpropane oxetane, 3-methyl-3-oxetanemethanol or trimethylolethane oxetane, further compounds having an oxetane group and one or more amino and/or hydroxyl groups, or suitable combinations thereof.

The cyclopropane component (A₂₆) may be selected, for example, from the series consisting of cyclopropanemethanol or cyclopropylmethanol or hydroxymethylcyclopropane, 1-cyclopropylethanol, 1,1-bis(hydroxymethyl)-cyclopropane, (1-methylcyclopropyl)methanol, (2-methylcyclopropyl)methanol, α-cyclopropylbenzyl alcohol, cyclopropylamine, cyclopropanemethylamine, further compounds having a cyclopropyl group and one or more amino and/or hydroxyl groups, or suitable combinations thereof, and the cyclobutane component (A₂₇) may be selected, for example, from the series consisting of cyclobutanol, cyclobutanemethanol, cyclobutylamine, further compounds having a cyclobutyl group and one or more amino and/or hydroxyl groups, or suitable combinations thereof.

Representative of hydroxy-functional lactone component (A₂₈) are, for example, γ-hydroxymethyl-γ-butyrolactone or 4,5-dihydro-5-hydroxymethyl-2(3H)-furanone or 5-hydroxymethyl-2-oxotetrahydrofuran, 5-hydroxymethyl-2(5H)-furanone, 2,4(3H,5H)-furandione or 3-oxo-γ-butyrolactone or tetronic acid or tautomeric 4-hydroxy-2(5H)-furanone, further compounds with a lactone group and/or with a cyclic acid anhydride group and one or more amino and/or hydroxyl groups, or suitable combinations thereof.

As a suitable fluorine-modified (meth)acrylate component (A₂₉) it is possible to use, for example, 3,3,4,4,5,5,6,6,7,7,8,8,8-tridecafluorooctyl acrylate, 3,3,4,4,5,5,6,6,7,7,8,8,9,9,10,10,10-heptadecafluorodecyl acrylate, 3,3,4,4,5,5,6,6,7,7,8,8,9,9,10,10,11,11,12,12,12-heneicosafluorododecyl acrylate, 3,3,4,4,5,5,6,6,7,7,8,8,8-tridecafluorooctyl methacrylate, 3,3,4,4,5,5,6,6,7,7,8,8,9,9,10,10,10-heptadecafluorodecyl methacrylate, 3,3,4,4,5,5,6,6,7,7,8,8,9,9,10,10,11,11,12,12,12-heneicosafluorododecyl methacrylate, the commercial products Fluowet AC 600, AC 812, MA 812 from Clariant GmbH, the commercial products R-1620, R-1820, R-2020, R-1633, R-1833, R-3633, R-3833, R-3620, R-3820, R-5610, R-5810, M-1620, M-1820, M-2020, M-1633, M-1833, M-3633, M-3833, M-3620, M-3820, M-5610, M-5810 from Daikin Industries, Ltd., or suitable combinations thereof.

A suitable latent curing component (A₃₀) is, for example, a compound having a reactive primary or secondary amino group and at least one latently reactive primary and/or secondary amino group and/or one or more latently reactive hydroxyl groups, such as latent curing agents based on N-(2-hydroxyethyl)ethylenediamine and mesityl oxide, described in WO 2004/099294 A1, latent curing agents based on diethylenetriamine and aldehydes or ketones without α-positioned H atoms, or suitable combinations thereof.

As a suitable (per)fluoroalkylalkylene isocyanate component (A₃₁) it is possible to use, for example, 3,3,4,4,5,5,6,6,7,7,8,8,8-tridecafluoro-1-isocyanatooctane, 3,3,4,4,5,5,6,6,7,7,8,8,9,9,10,10,10-heptadecafluoro-1-isocyanatodecane, 3,3,4,4,5,5,6,6,7,7,8,8,9,9,10,10,11,11,12,12,12-heneicosafluoro-1-isocyanatododecane, 3,3,4,4,5,5,6,6,7,7,8,8,9,9,10,10,11,11,12,12,13,13,14,14,14-pentacosafluoro-1-isocyanatotetradecane, 3,3,4,4,5,5,6,6,7,7,8,8,9,9,10,10,11,11,12,12,13,13,14,14,15,15,16,16,16-nonacosafluoro-1-isocyanatohexadecane or suitable combinations thereof.

Suitable for use as (per)fluoroalkylalkanecarboxylic acid derivative component (A₃₂) is, for example, tridecafluoroheptanoyl chloride, pentadecafluorooctanoyl chloride, heptadecafluorononanoyl chloride, nonadecafluorodecanoyl chloride, heneicosafluoroundecanoyl chloride, (m)ethyl tridecafluoroheptanoate, (m)ethyl pentadecafluorooctanoate, (m)ethyl heptadecafluorononanoate, (m)ethyl nonadecafluorodecanoate, (m)ethyl heneicosafluoroundecanoate, the commercial products C-1708, C-5608, C-5808, S-1701, S-1702, S-5602, S-5802 from Daikin Industries, Ltd., or suitable combinations thereof.

Regarded as a suitable polyhedral oligomeric polysilasesquioxane component (A₃₃) are polysilasesquioxanes having one or more amino and/or hydroxyl and/or isocyanato and/or mercapto groups and one or more perfluoroalkyl groups of the general formula

(R⁷ᵤR⁸ᵥR⁹_{w}SiO_{1.5})ₚ

with 0<u<1, 0<v<1,0<w<1,u+v+w=1, p=4, 6, 8, 10, 12 and R⁷, R⁸, R⁹=independently of one another any inorganic and/or organic and optionally polymeric radical having 1-250 C atoms and 1-50 N and/or 0-50 and/or 3-100 F and/or 0-50 Si and/or 0-50 S atoms,

the commercial products Creasil® from Degussa AG, the commercial products POSS® from Hybrid Plastics, Inc., or suitable combinations thereof.

As suitable alkylene 1-oxide component (A₃₄) it is possible to make use for example of 1,2-epoxydecane, 1,2-epoxyundecane, 1,2-epoxydodecane, 1,2-epoxytridecane, 1,2-epoxytetradecane, 1,2-epoxypentadecane, 1,2-epoxyhexadecane, 1,2-epoxyheptadecane, 1,2-epoxyoctadecane, 1,2-epoxynonadecane, 1,2-epoxyeicosane, higher epoxyalkanes, or suitable combinations thereof.

In connection with the hydrophobicizing and oleophobicizing component (A), the present invention encompasses numerous representatives of reaction products (1) to (35). The following products are regarded as being particularly suitable:

Typical reaction products (1) are adducts of perfluoroalkylethanol mixtures, isophorone diisocyanate, and diethanolamine or diisopropanolamine or trimethylolmethylamine in a molar ratio of 1:1:1.

Preferred reaction products (4) are adducts of perfluoroalkylethanol mixtures, phosgene or ethyl chloroformate or diethyl carbonate and diethanolamine or diisopropanolamine or trimethylolmethylamine in a molar ratio of 1:1:1. Likewise suitable are adducts of chloroformates and/or phosgene derivatives of perfluoroalkylethanol mixtures and diethanolamine or diisopropanolamine or trimethylolmethylamine in a molar ratio of 1:1.

Suitable reaction products (5) are represented by adducts of perfluoroalkylethanol mixtures, N-methylethanolamine, and HDI triisocyanurate in a molar ratio of 1:2:1, suitability also being possessed by adducts of perfluoroalkylethanol mixtures, diethanolamine or diisopropanolamine or trimethylolmethylamine, and HDI triisocyanurate in a molar ratio of 2:1:1.

Typical reaction products (6) are adducts of perfluoroalkylethanol mixtures, diethanolamine or diisopropanolamine or trimethylolmethylamine, monofunctional methylpolyethylene glycols with an average molecular mass (number average) of 500-2000 daltons, and HDI triisocyanurate in a molar ratio of 1:1:1:1.

Adducts of perfluoroalkylethanol mixtures, N-methylethanolamine, and cyanuric chloride in a molar ratio of 1:2:1 can be used as reaction products (7), mention being made among others of adducts of perfluoroalkylethanol mixtures, diethanolamine or diisopropanolamine or trimethylolmethylamine, and cyanuric chloride in a molar ratio of 2:1:1.

Regarded as being suitable reaction products (8) are adducts of perfluoroalkylethanol mixtures, diethanolamine or diisopropanolamine or trimethylolmethylamine, monofunctional methylpolyethylene glycols with an average molecular mass (number average) of 500-2000 daltons, and cyanuric chloride in a molar ratio of 1:1:1:1, and, as reaction products (9), adducts of perfluoroalkylethanol mixtures, diethanolamine or diisopropanol amine or trirethylolmethylamine, hydroxypivalic acid, and HDI triisocyanurate in a molar ratio of 1:1:1:1.

Suitable reaction products (10) are represented by adducts of perfluoroalkylethanol mixtures, diethanolamine or diisopropanolamine or trimethylolmethylamine, cyanamide, and HDI triisocyanurate in a molar ratio of 1:1:1:1.

Preferred reaction products (11) in the context of the present invention are adducts of perfluoroalkylethanol mixtures, diethanolamine or diisopropanolamine or trimethylolmethylamine, hydroxypivalic acid, and cyanuric chloride in a molar ratio of 1:1:1:1.

The invention, with respect to reaction products (12), considers suitability to be possessed by adducts of perfluoroalkylethanol mixtures, diethanolamine or diisopropanolamine or trimethylolmethylamine, cyanamide, and cyanuric chloride in a molar ratio of 1:1:1:1.

Reaction products (13) include adducts of perfluoroalkylethanol mixtures, diethanolamine or diisopropanolamine or trimethylolmethylamine, hydrophobically modified polyols of low molecular mass, and isophorone diisocyanate in a molar ratio of 1:1:1:2.

Adducts of perfluoroalkylethanol mixtures, diethanolamine or diisopropanol amine or trimethylolmethylamine, polyfunctional polyalkylene glycols, and isophorone diisocyanate in a molar ratio of 1:1:1:2 are suitable reaction products (14).

Considered suitable reaction products (15) are, in the present context, adducts of perfluoroalkylethanol mixtures, tall oil fatty acid, and bisphenol A diglycidyl ether in a molar ratio of 1:1:1, as are adducts of perfluoroalkylcarboxylic acid mixtures, tall oil fatty acid, and bisphenol A diglycidyl ether in a molar ratio of 1:1:1.

The invention regards, as preferred low molecular mass polyol component (B₁), ethylene glycol or ethane-1,2-diol, propane-1,3-diol and isomers, butane-1,4-diol and isomers, 2-methylpropane-1,3-diol or the commercial product MPDiol® Glycol from GEO Specialty Chemicals Ltd., pentane-1,5-diol and isomers, neopentyl glycol or 2,2-dimethylpropane-1,3-diol, hexane-1,6-diol and isomers, heptane-1,7-diol and isomers, octane-1,8-diol and isomers, nonane-1,9-diol and isomers, cyclohexanedimethanol or 1,4-bis(hydroxymethyl)cyclohexane, hydrogenated bisphenol A or hydrogenated bisphenol F, glycerol, trimethylolmethane or trishydroxymethyl)methane or 2-hydroxymethylpropane-1,3-diol, trimethylolethane or tris(hydroxymethyl)ethane or 2-hydroxymethyl-2-methylpropane-1,3-diol, trimethylolpropane or tris(hydroxymethyl)propane or 2-hydroxymethyl-2-ethylpropane-1,3-diol, pentaerythritol, ditrimethylolpropane, dipentaerythritol, tris(hydroxymethyl)methane monoallyl ether, tris(hydroxymethyl)ethane monoallyl ether, tris(hydroxymethyl)propane monoallyl ether, glycerol 1-allyl ether or suitable combinations thereof, with particular preference being accorded to butane-1,4-diol and/or trimethylolpropane.

With regard to component (B₂), the polyurethane resin of the invention is based in particular on 1,2-dihydroxyalkanediols having 10 to 50 carbon atoms of the general formula

CₙH₂ₙ₊₁—CHOH—CH₂OH

with n=8-48

and/or

reaction products, having two or more hydroxyl groups, of 5% to 95% by weight of an alkylene 1-oxide component (A₃₄) of the general formula

CₙH₂ₙ₊₁—CHOCH₂

with n=8-48

and 95% to 5% by weight of an amino alcohol component (A₄) and/or of a mercapto alcohol component (A₅), the reaction having been carried out preferably in a molar ratio of 1:1 in any desired way,

and/or

α,ω-dihydroxyalkanediols having 10-50 carbon atoms of the general formula

HO—CₙH₂ₙ—OH

with n=10-50

and/or

reaction products, having two or more hydroxyl groups, of 5% to 95% by weight of an (un)saturated fatty alcohol component (A₁₇) and/or of an (un)saturated fatty amine component (A₁₈) and/or of an (un)saturated fatty acid component (A₁₉), 75% to 5% by weight of a difunctional polyisocyanate component (C₁), 75% to 5% by weight of an amino alcohol component (A₄) and/or of a mercapto alcohol component (A₅), the reaction having been carried out preferably in a molar ratio of 1:1:1 in any desired way.

As suitable hydrophobically modified, low molecular mass polyol component (B₂) it is possible to make use, for example, of decane-1,2-diol, undecane-1,2-diol, dodecane-1,2-diol, tridecane-1,2-diol, tetradecane-1,2-diol, pentadecane-1,2-diol, hexadecane-1,2-diol, heptadecane-1,2-diol, octadecane-1,2-diol, nonadecane-1,2-diol, eicosane-1,2-diol, heneicosane-1,2-diol, docosane-1,2-diol, tricosane-1,2-diol, tetracosane-1,2-diol, pentacosane-1,2-diol, higher 1,2-diols, compounds having two or more hydroxyl groups such as polyols based on 1,2-epoxydecane, 1,2-epoxyundecane, 1,2-epoxydodecane, 1,2-epoxytridecane, 1,2-epoxytetradecane, 1,2-epoxypentadecane, 1,2-epoxyhexadecane, 1,2-epoxyheptadecane, 1,2-epoxyoctadecane, 1,2-epoxynonadecane, 1,2-epoxyeicosane, higher 1,2-epoxyalkanes, amino alcohols and/or mercapto alcohols or suitable combinations thereof, decane-1,10-diol, undecane-1,11-diol, dodecane-1,12-diol, tridecane-1,13-diol, tetradecane-1,14-diol, pentadecane-1,15-diol, hexadecane-1,16-diol, heptadecane-1,17-diol, octadecane-1,18-diol, nonadecane-1,19-diol, eicosane-1,20-diol, heneicosane-1,21-diol, docosane-1,22-diol, tricosane-1,23-diol, tetracosane-1,24-diol, pentacosane-1,25-diol, higher α,ω-diols, or suitable combinations thereof.

Regarded as being suitable anionically modifiable and/or cationically modifiable polyol components (B₃) are, for example, anionically modifiable polyols such as 2-hydroxymethyl-3-hydroxypropanoic acid or dimethylolacetic acid, 2-hydroxymethyl-2-methyl-3-hydroxypropanoic acid or dimethylolpropionic acid or the commercial product DMPA® from GEO Specialty Chemicals Ltd., 2-hydroxymethyl-2-ethyl-3-hydroxypropanoic acid or dimethylolbutyric acid, 2-hydroxymethyl-2-propyl-3-hydroxypropanoic acid or dimethylolvaleric acid, citric acid, tartaric acid, [tris(hydroxymethyl)methyl]-3-aminopropanesulfonic acid (TAPS, Raschig GmbH), or cationically modifiable polyols such as N-methyldiethanolamine, N-ethyldiethanolamine, N-butyldiethanolamine, N-tert-butyldiethanolamine, triethanolamine, triisopropanolaamine, 3-dimethylamino-1,2-propanediol, or suitable combinations thereof, with preference being given to dimethylolpropionic acid and/or N-methyldiethanolamine.

Component (B₄) preferably comprises reaction products, having two or more hydroxyl groups, of 5% to 95% by weight of a monofunctional polyalkylene glycol component (A₉) and/or of a monofunctional polyoxyalkylenamine component (A₁₀), 75% to 5% by weight of a difunctional polyisocyanate component (C₁), 75% to 5% by weight of an amino alcohol component (A₄) and/or of a mercapto alcohol component (A₅), the reaction having been carried out preferably in a molar ratio of 1:1:1 in any desired way.

As suitable nonionically hydrophilic, polymeric polyol component (B₄) it is also possible, however, to use reaction products of methyl-polyethylene glycols, isophorone diisocyanate, and diethanolamine, reaction products of methyl-polyethylene glycols, isophorone diisocyanate, and diisopropanolamine, reaction products of methyl-poly(ethylene oxide-block/co-propylene oxide), isophorone diisocyanate, and diethanolamine, reaction products of methyl-poly(ethylene oxide-block/co-propylene oxide), isophorone diisocyanate, and diisopropanolamine, or suitable combinations thereof.

Suitable high molecular mass (polymeric) polyol components (B₅) in accordance with the invention are, in particular, (hydrophobically modified) polyalkylene glycols, (un)saturated aliphatic and/or aromatic polyesters, polycaprolactones, polycarbonates, polycarbonate-polycaprolactone combinations, α,ω-polybutadienepolyols, α,ω-polymethacrylatediols, α,ω-polysulfidediols, α,ω-dihydroxyalkylpolydimethylsiloxanes, hydroxy-functional epoxy resins, hydroxy-functional ketone resins, alkyd resins, mono- and/or di- and/or triesters of glycerol and (un)saturated and optionally hydroxy-functional fatty acids having 1 to 30 carbon atoms and having a functionality of f_{OH}≧2, dimer fatty acid dialcohols, reaction products based on bisepoxides and/or trisepoxides and (un)saturated fatty acids, further hydroxy-functional macromonomers and telechelics of all kinds, hybrid polymers of all kinds, or suitable combinations thereof. Mention may be made here, among others, of polyalkylene glycols, such as, for example, polyethylene glycols, polypropylene glycols, polytetramethylene glycols or polytetrahydrofurans, hydrophobically modified block copolymers, consisting of 10% to 90% by weight of a polymer having hydrophobicizing properties and 90% to 10% by weight of a polypropylene oxide polymer, use being made of hydrolysis-stable block copolymers with ABA, BAB or (AB)ₙ structure, and A being a polymer segment having hydrophobicizing properties such as polybutylene oxide, polydodecyl oxide, polyisoamyl oxide, poly-α-pinene oxide, polystyrene oxide, polytetramethylene oxide, polyoxetane, substituted polyoxetanes, further aliphatic or aromatic polyoxyalkylenes having 3 to 30 carbon atoms per alkylene oxide, α,ω-polymethacrylate diols, α,ω-dihydroxyalkylpolydimethylsiloxanes, macromonomers, telechelics or mixtures thereof, and B being a polymer segrnent based on polypropylene oxide, or hydrophobic block copolymers, consisting of two or more hydrophobic alkylene oxides, use being made of hydrolysis-stable block copolymers having A₁A₂A₃ or (A₁A₂), structure, and A₁, A₂, and A₃ each being polymer segments having hydrophobicizing properties such as polybutylene oxide, polydodecyl oxide, polyisoamyl oxide, poly-α-pinene oxide, polystyrene oxide, polytetramethylene oxide, polyoxetane, substituted polyoxetanes, further aliphatic or aromatic polyoxyalkylenes having 3 to 30 carbon atoms per alkylene oxide, α,ω-polymethacrylate diols, α,ω-dihydroxyalkylpolydimethylsiloxanes, macromonomers, telechelics or mixtures thereof, or hydrophobically modified random copolymers, consisting of 10% to 90% by weight of a hydrophobic alkylene oxide such as butylene oxide, dodecyl oxide, isoamyl oxide, α-pinene oxide, styrene oxide, oxetane, substituted oxetanes, further aliphatic or aromatic alkylene oxides having 3 to 20 carbon atoms or mixtures thereof, in combination with suitable starter molecules, and 90% to 10% by weight of propylene oxide, such as the hydrophobically modified polyether polyols known from EP 1 313 784 B1. Examples of suitable aliphatic or aromatic polyesters are condensates based on low molecular mass polyols such as ethylene glycol or ethane-1,2-diol, butane-1,4-diol, hexane-1,6-diol, neopentyl glycol or 2,2-dimethylpropane-1,3-diol, 2-hydroxymethyl-2-methylpropane-1,3-diol, trimethylolpropane or tris(hydroxymethyl)propane, and polycarboxylic acids such as hexanedioic acid or adipic acid, fumaric acid, maleic acid, maleic anhydride, 1,2-benzenedicarboxylic acid or phthalic acid, 1,3-benzenedicarboxylic acid or isophthalic acid, 1,4-benzenedicarboxylic acid or terephthalic acid, 2-hydroxymethyl-2-methyl-3-hydroxypropanoic acid or dimethylolpropionic acid, 5-sulfoisophthalic acid sodium or its esters such as the commercial product Desmophen® from Bayer AG and the commercial product Oxyester T 1136 from Degussa AG. Examples of suitable polycaprolactones are polyadducts based on low molecular mass polyols as starters and ε-caprolactone, such as the commercial products PolyTHF® from BASF AG and the commercial products CAPA® from Solvay Interox Ltd. Examples of suitable polycarbonates are condensates based on dialkyl carbonates or diaryl carbonates and low molecular mass polyols, such as the commercial products Desmophen® C1200, Desmophen® XP 2501 (polyestercarbonatediols), Desmophen® C 2200, Desmophen® XP 2586 (polycarbonatediols) from Bayer AG. Typical α,ω-polymethacrylatediols include, for example, the commercial products TEGO® Diol BD 1000, TEGO® Diol MD 1000 N, TEGO® Diol MD 1000× from Degussa AG. Preference is given to using (hydrophobically modified) polyalkylene glycols and/or (un)saturated aliphatic and/or aromatic polyesters and/or polycaprolactone and/or polycarbonate and/or polycarbonate-polycaprolactone combinations.

Suitable representatives of polyisocyanate component (C) are, for example, polyisocyanates, polyisocyanate derivatives or polyisocyanate homologs with two or more aliphatic and/or aromatic isocyanate groups of like or different reactivity, or suitable combinations thereof. Suitability is possessed in particular by the polyisocyanates that are well known in polyurethane chemistry, or combinations thereof. Examples of preferred aliphatic polyisocyanates are 1,6-diisocyanatohexane (HDI), 1-isocyanato-5-isocyanatomethyl-3,3,5-trimethylcyclohexane or isophorone diisocyanate (IPDI, commercial product VESTANAT® IPDI from Degussa AG), bis(4-isocyanatocyclohexyl)methane (H₁₂MDI, commercial product VESTANAT® H12MDI from Degussa AG), 1,3-bis(1-isocyanato-1-methylethyl)benzene (m-TMXDl), 2,2,4-trimethyl-1,6-diisocyanatohexane or 2,4,4-trimethyl-1,6-diisocyanatohexane (TMDI, commercial product VESTANAT® TMDI from Degussa AG), diisocyanates based on dimer fatty acid (commercial product DDI® 1410 DIISOCYANATE from Cognis Deutschland GmbH & Co. KG) or technical isomer mixtures of the individual aliphatic polyisocyanates. Considered suitable aromatic polyisocyanates are, for example, 2,4-diisocyanatotoluene or toluene diisocyanate (TDI), bis(4-isocyanatophenyl)methane (MDI) and its higher homologs, (polymeric MDI), or technical isomer mixtures of the individual aromatic polyisocyanates. Also suitable in principle are the “paint polyisocyanates” based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI). The term “paint polyisocyanates” identifies derivatives of these diisocyanates which contain allophanate, biuret, carbodiimide, iminooxadiazinedione, isocyanurate, oxadiazinetrione, uretdione and/or urethane groups and in which the residual monomeric diisocyanate content has been reduced to a minimum in accordance with the prior art. In addition it is also possible to use modified polyisocyanates as well, obtainable, for example, by hydrophilic modification of bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) with monohydroxy-functional polyethylene glycols or aminosulfonic acid sodium salts. Typical representatives of these “paint polyisocyanates” are the commercial products VESTANAT® T 1890 E, VESTANAT® T 1890 L, VESTANAT® T 1890 M, VESTANAT® T 1890 SV, VESTANAT® T 1890/100 (polyisocyanates based on IPDI trimer), VESTANAT® HB 2640 MX, VESTANAT® HB 2640/100, VESTANAT® HB 2640/LV (polyisocyanates based on HDI biuret), VESTANAT® HT 2500 L, VESTANAT® HB 2500/100, VESTANAT® HB 2500/LV (polyisocyanates based on HDI isocyanurate) from Degussa AG, the commercial product Basonat® HW 100 from BASF AG, the commercial products Bayhydur® 3100, Bayhydur® VP LS 2150 BA, Bayhydur® VP LS 2306, Bayhydur® VP LS 2319, Bayhydur® VP LS 2336, Bayhydur® XP 2451, Bayhydur® XP 2487, Bayhydur® XP 2487/1, Bayhydur® XP 2547, Bayhydur® XP 2570, Desmodur® N 3600, Desmodur® XP 2410 and Desmodur® XP 2565 from Bayer AG, the commercial products Rhodocoat® X EZ-M 501, Rhodocoat® X EZ-M 502, and Rhodocoat® WT 2102 from Rhodia.

As difunctional polyisocyanate component (C₁), the present invention provides, for example, for 1,6-diisocyanatohexane (HDI), 1-isocyanato-5-isocyanatomethyl-3,3,5-trimethylcyclohexane or isophorone diisocyanate (IPD1), bis(4-isocyanatocyclohexyl)methane (H₁₂MDI), 1,3-bis(1-isocyanato-1-methylethyl)benzene (m-TMXDI), 2,2,4-trirethyl-1,6-diisocyanatohexane or 2,4,4-trimethyl-1,6-diisocyanatohexane (TMDI), or suitable combinations thereof, with preference being given to isophorone diisocyanate.

As polyisocyanate component (C₂) with a functionality of three or more, the invention takes account preferably of “paint polyisocyanates” that contain allophanate, biuret, optionally carbodiimide, optionally iminooxadiazinedione, isocyanurate but also optionally oxadiazinetrione, optionally uretdione and urethane groups and are based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) or suitable combinations thereof, preference being given to an isocyanurate of 1,6-diisocyanatohexane.

As suitable polyisocyanate component (C₃) modified with uretdione groups it is possible for example to use “paint polyisocyanates” that contain uretdione groups and are based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPD1) or suitable combinations thereof. In this context the claimed PU resin ought in terms of its component (A) to be based preferably on a uretdione of 1,6-diisocyanatohexane such as the commercial product Desmoduro N 3400.

With regard to the polyisocyanate component (C₄₋) modified with sodium sulfonate groups, the invention employs hydrophilically modified “paint polyisocyanates” that contain allophanate, biuret, carbodiimide, isocyanurate, oxadiazinetrione, uretdione, urethane groups and are based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) or suitable combinations thereof. Preference is given to using an isocyanurate of 1,6-diisocyanatohexane that is modified with 3-cyclohexylamino-1-propanesulfonic acid sodium salt, such as the commercial products Bayhydur® XP 2487, Bayhydur® XP 2487/1, Bayhydur® XP.

Advisable in accordance with the present invention are PU resins which in terms of their component (A) are based on a polyisocyante component (C₅) which is modified with unsaturated groups and which is, for example, vinyl isocyanate, 2-isocyanatoethyl methacrylate, 1-(1-isocyanato-1-methylethyl)-3-(2-propenyl)benzene or α,α-dimethyl-3-isopropenylbenzyl isocyanate, or suitable combinations thereof. Preference is given to using 2-isocyanatoalkyl methacrylates.

As suitable polyisocyanate component (C₆) modified with ester groups, use is made preferably of isocyanatoalkylalkanoic esters. All in all, high suitability as component (C₆) is possessed by methyl isocyanatoformate, ethyl isocyanatoformate, phenyl isocyanatoformate, ethyl isocyanatoacetate, ethyl 4-isocyanatobutyrate, butyl 4-isocyanatobutyrate, methyl 2-isocyanato-3-methylbutyrate, ethyl 2-isocyanatohexanoate, butyl 2-isocyanatobenzoate, butyl 4-isocyanatobenzoate, methyl 3-isocyanato-2-methylbenzoate, methyl 2-isocyanato-3-phenylpropionate, dimethyl 5-isocyanatophthalate, or suitable combinations thereof.

Examples of suitable neutralizing components (D) include monoacid or polyacid organic bases such as trimethylamine, triethylamine, tripropylamine, triisopropylamine, tributylamine, N,N-dimethylethylamine, N,N-dimethylpropylamine, N,N-dimethylisopropylamine, N-methylmorpholine, N-ethylmorpholine, N,N-dimethylethanolamine, N,N-dimethylpropanolamine, N,N-dimethylisopropanolamine, N,N-diethylethanolamine, N,N-dibutylethanolamine, N-methyldiethanolamine, N-ethyldiethanolamine, N-butyldiethanolamine, N-tert-butyldiethanolamine, triethanolamine, triisopropanolamine, 3-dimethylamino-1,2-propanediol, monoacid or polyacid inorganic bases such as ammonia, lithium hydroxide, sodium hydroxide, potassium hydroxide, mono- or polybasic organic acids such as formic acid, acetic acid, oxalic acid, malonic acid, citric acid, monobasic or polybasic inorganic acids such as amidosulfonic acid, hydrochloric acid, sulfuric acid, phosphoric acid or suitable combinations thereof. Preference is given to using triethylamine and/or formic acid.

As (polymeric) chain extender and/or chain terminator component (E) it is possible to employ, for example, chain extenders such as adipic dihydrazide, ethylenediamine, 4,4′-diaminodicyclohexylmethane, diethylenetriamine, triethylenetetramine, tetraethylenepentamine, pentaethylenehexamine, dipropylenetriamine, hexamethylenediamine, hydrazine (hydrate), isophorone diamine, 4,9-dioxadodecane-1,12-diamine, 4,7,10-trioxamidecane-1,13-diamine, polyoxyethylenepolyamines, polyoxypropylenepolyamines, polytetrahydrofuranpolyamines, other polyoxyalkylenepolyamines based on any alkylene oxides or mixtures thereof (co, block; random), polyethylenimines, polyamidoamines, N-(2-hydroxyethyl)ethylenediamine, N,N′-bis(2-hydroxyethyl)ethylenediamine, adducts of salts of 2-acrylamido-2-methylpropane-1-sulfonic acid and ethylenediamine, adducts of salts of (meth)acrylic acid and polyamines such as ethylenediamine, adducts of 1,3-propane sulfone or 1,4-butane sultone and polyamines such as ethylenediamine, the commercial products JEFFAMINE® D-230, JEFFAMINE® D-400, JEFFAMINE® D-2000, JEFFAMINE® XTJ-510 (D-4000), JEFFAMINE® HK-511 (XTJ-511), JEFFAMINE® XTJ-500 (ED-600), JEFFAMINE® XTJ-502 (ED-2003), JEFFAMINE® T-403, JEFFAMINE® T-5000, JEFFAMINE® XTJ-503 (T-3000) from Huntsman Corporation, chain terminators such as ethanolamine, N-methylethanolamine, diethanolamine, diisopropanolamine, 3-((2-hydroxyethyl)amino)-1-propanol, tris(hydroxymethyl)aminomethane or trimethylolmethylamine, amino sugars such as galactosamine, glucamine, glucosamine, neuramic acid, trimethylolmethane or tris(hydroxymethyl)methane or 2-hydroxymethylpropane-1,3-diol, trimethylolethane or tris(hydroxymethyl)ethane or 2-hydroxymethyl-2-methylpropane-1,3-diol, trimethylolpropane or tris(hydroxymethyl)propane or 2-hydroxymethyl-2-ethylpropane-1,3-diol, pentaerythritol, ditrimethylolpropane, dipentaerythritol, the commercial products JEFFAMINE® XTJ-505 (M-600), JEFFAMINE® XTJ-506 (M-1000), JEFFAMINE® XTJ-507 (M-2005), JEFFAMINE® M-2070 from Huntsman Corporation, or suitable combinations thereof. It is preferred to use ethylenediamine and/or diethanolamine.

Suitable reactive nanoparticle components (F) are represented, for example, by amino- and/or hydroxyl- and/or mercapto- and/or isocyanato- and/or epoxy- and/or methacryloyl- and/or silane-modified nanoparticles, such as fumed silica (SiO₂) (such as AEROSIL® fumed silicas, for example) or fumed silicas doped with rare earths (RE) (such as AEROSIL® fumed silicas/RE doped), silver-doped fumed silicas (such as AEROSIL® fumed silicas/Ag doped), silicon dioxide-aluminum oxide mixture (mullite) (such as AEROSOIL® fumed silicas+Al₂O₃), silicon dioxide-titanium dioxide mixture (such as AEROSIL® fumed silicas+TiO₂), aluminum oxide (Al₂O₃) (such as AEROXIDE® AluC), titanium dioxide (TiO₂) (such as AEROXIDE® TiO₂ P25), zirconium dioxide (ZrO₂) (VP Zirkonoxid PH), yttrium-stabilized zirconium dioxide (such as VP Zirkonoxid 3YSZ), cerium dioxide (CeO₂) (such as AdNano® Ceria), indium tin oxide (ITO, In₂O₃/SnO₂) (such as Adnano® ITO), nanoscale iron oxide (Fe₂O₃) in a matrix of fiuned silica (such as AdNano® MagSilica), zinc oxide (ZnO) (such as AdNano® Zinc Oxide from Degussa AG), or suitable combinations thereof. It is preferred to use nanoparticles based on silicon dioxide and/or titanium dioxide and/or zinc oxide or suitable combinations thereof, the nanoparticles being in solid form or in the form of dispersions and/or pastes. Provision is made in particular for at least 50% by weight of the overall component (F) to have a particle size of not more than 500 nm (standard: DIN 53206-1, Testing of pigments; Particle size analysis, Basic terms) and the entirety of the particles with this particle size possessed a specific surface area (standard: DIN 66131, Determination of the specific surface area of solids by gas adsorption by the method of Brunauer, Emmet, and Teller (BET)) of 10 to 200 m²/g. In accordance with a further variant of the invention, at least 70% by weight, preferably at least 90% by weight, of the total component (F) is to have a particle size of 10 to 300 nm (standard: DIN 53206-1, Testing of pigments; Particle size analysis, Basic terms) and the entirety of the particles with this particle size possessed a specific surface area (standard: DIN 66131, Determination of the specific surface area of solids by gas adsorption by the method of Brunauer, Emmet, and Teller (BET)) of 30 to 100 m²/g.

As suitable solvent component (G) it is possible, for example, to use low-boiling solvents that are inert toward isocyanate groups, such as acetone or propanone, butanone, 4-methyl-2-pentanone, ethyl acetate, n-butyl acetate, or high-boiling solvents that are inert toward isocyanate groups, such as the commercial products N-methyl-2-pyrrolidone and N-ethyl-2-pyrrolidone from BASF AG, diethylene glycol dimethyl ether, dipropylene glycol dimethyl ether or the commercial product Proglyde DMM® from Dow Chemical Company, ethylene glycol monoalkyl ether acetates, diethylene glycol monoalkyl ether acetates or suitable combinations thereof. It is preferred to use N-ethylpyrrolidone. The solvent component (G) can be removed again in whole or in part by distillation following the preparation of the binder component (I), or may remain in the binder component (I).

For the catalyst component (H), suitability is possessed by Lewis acids such as dibutyltin oxide, dibutyltin dilaurate (DBTL), tin(II) octoate, (concentrated) sulfuric acid, Lewis bases such as triethylamine, 1,4-diazabicyclo[2.2.2]octane (DABCO), 1,4-diazabicyclo[3.2.0]-5-nonene (DBN), 1,5-diazabicyclo[5.4.0]-7-undecene (DBU), morpholine derivatives such as JEFFCAT® Amine Catalysts from Huntsman Corporation, for example, or suitable combinations thereof. It is preferred to use dibutyltin dilaurate.

The choice of the water component (1) is completely uncritical. Suitability is possessed, for example, by spring waters, distilled or demineralized water, or suitable combinations thereof.

The curing component (II) may be selected, for example, from the “paint polyisocyanates” based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) or suitable combinations thereof. The term “paint polyisocyanates” identifies derivatives of these diisocyanates which contain allophanate, biuret, carbodiimide, iminooxadiazinedione, isocyanurate, oxadiazinetrione, uretdione and/or urethane groups and in which the residual monomeric diisocyanate content has been reduced to a minimum in accordance with the prior art. In addition it is also possible to use modified polyisocyanates as well, obtainable, for example, by hydrophilic modification of “paint polyisocyanates” based on bis(4-isocyanatocyclohexyl)methane (H₁₂MDI), 1,6-diisocyanatohexane (HDI), 1-isocyanato-5-isocyanatomethyl-3,3,5-trimethylcyclohexane (IPDI) with monohydroxy-functional polyethylene glycols or aminosulfonic acid sodium salts. Typical representatives of these “paint polyisocyanates” are the commercial products VESTANA® T 1890 E, VESTANA® T 1890 L, VESTANA® T 1890 M, VESTANAT® T 1890 SV, VESTANAT® T 1890/100 (polyisocyanates based on IPDI trimer), VESTANAT® HB 2640 MX, VESTANAT® HB 2640/100, VESTANAT® HB 2640/LV (polyisocyanates based on HDI biuret), VESTANAT® HT 2500 L, VESTANAT® HB 2500/100, VESTANAT® HB 2500/LV (polyisocyanates based on HDI isocyanurate) from Degussa AG, the commercial product Basonat® HW 100, Basonat® HW 180 PC, Basonat® HA 100, Basonat® HA 200 and Basonat® HA 300 from BASF AG, the commercial products Bayhydur® 3100, Bayhydurt VP LS 2150 BA, Bayhydur® VP LS 2306, Bayhydur® VP LS 2319, Bayhydur® VP LS 2336, Bayhydur® XP 2451, Bayhydur® XP 2487, Bayhydur® XP 2487/1, Bayhydur® XP 2547, Bayhydur® XP 2570 and Desmodur® XP 2565 from Bayer AG, the commercial products Rhodocoat® X EZ-M 501, Rhodocoat® X EZ-M 502 and Rhodocoat® WT 2102 or suitable combinations thereof. The present invention provides, as preferred representatives of the curing component (II), polyfunctional diisocyanatohexane derivatives and suitable combinations thereof.

The polyurethane resin of the invention may, in addition to the binder component (I) and the curing component (II), also comprise a formulating component (III). In this respect, the present invention provides for the functionalized polyurethane resin to be based on (functionalized and/or reactive) inorganic and/or organic fillers and/or lightweight fillers, (functionalized) inorganic and/or organic pigments and carrier materials, (functionalized and/or reactive) inorganic and/or organic nanomaterials, inorganic and/or organic fibers, graphite, carbon black, carbon fibers, metal fibers and metal powders, conductive organic polymers of all kinds, further polymers and/or polymer dispersions of all kinds, redispersible dispersion powders of all kinds, superabsorbents of all kinds, further inorganic and organic compounds of all kinds, plasticizers, defoamers, deaerating agents, slip additives and flow-control additives, substrate wetting additives, wetting and dispersing additives, hydrophobicizing agents, rheological additives, coalescence assistants, matting agents, adhesion promoters, antifreeze agents, antioxidants, UV stabilizers, biocides, water, solvents, and further catalysts of all kinds, as formulating component (III).

Also provided is a resin variant in whose preparation components (F) and (III), when the resin was prepared, were in coated and/or microencapsulated and/or carrier-fixed and/or hydrophilicized and/or solvent-containing form and have been released optionally in a delayed way.

According to one specific resin variant, the NCO/(OH+NH₍₂₎) equivalent ratio of the polyurethane prepolymer comprising components (A), (B), (C), and optionally (F) ought to have been adjusted to a value of 1.25 to 2.5, preferably 1.5 to 2.25.

The degree of neutralization of the polyurethane oligomer or polymer comprising components (A), (B), (C), optionally (D), optionally (E), and optionally (F) ought to have been adjusted to 50 to 100 equivalent %, preferably 60 to 90 equivalent %, based on the carboxylic and/or phosphonic and/or sulfonic acid group(s) and/or tertiary amino group(s).

Further embraced by the present invention is a functionalized polyurethane resin wherein the charge density of the polyurethane oligomer or polymer comprising components (A), (B), (C), optionally (D), optionally (E), and optionally (F) ought to have been adjusted to 5 to 50 meq·(100 g)⁻¹, preferably to 15 to 35 meq·(100 g)⁻¹, and the acid number of the polyurethane oligomer or polymer comprising components (A), (B), (C), optionally (D), optionally (E), and optionally (F) has been adjusted to 2.5 to 30 meq KOH-g⁻¹, preferably to 7.5 to 20 meq KOH-g⁻¹.

In a further variant of the polyurethane resin of the invention, the degree of chain extension and/or chain termination of the polyurethane oligomer or polymer comprising components (A), (B), (C), optionally (D), optionally (E), and optionally (F) ought to have been adjusted to 0 to 100 equivalent %, preferably 80 to 90 equivalent %, based on the free isocyanate groups of the polyurethane prepolymer comprising components (A), (B), and (C).

Furthermore, provision is made for the degree of functionalization in terms of free amino and/or hydroxyl groups of the polyurethane oligomer or polymer comprising components (A), (B), (C), optionally (D), optionally (E), and optionally (F) to have been adjusted to 0 to 500 equivalent %, preferably 0 to 300 equivalent %, based on the free isocyanate groups of the polyurethane prepolymer comprising components (A), (B), and (C).

In certain cases it has emerged as being favorable if, during the preparation of the functionalized polyurethane resin of the invention, the polyethylene oxide content of the polyurethane oligomer or polymer comprising components (A), (B), (C), optionally (D), optionally (E), and optionally (F) has been adjusted to 0% to 10% by weight, preferably to 2% to 8% by weight.

The fluorine content of the polyurethane oligomer or polymer comprising components (A), (B), (C), optionally (D), optionally (E), and optionally (F) has been adjusted to 0.01% to 10% by weight, preferably to 0.5% to 5% by weight.

Likewise preferred is a functionalized polyurethane resin for whose preparation the average molecular mass (number average) of the polyurethane oligomer or polymer comprising components (A), (B), (C), optionally (D), optionally (E), and optionally (F) has been adjusted to 10 000 to 1000 000 daltons.

In a further preferred variant, the solids content in terms of polyurethane oligomer or polymer comprising components (A), (B), (C), optionally (D), optionally (E), and optionally (F) ought to have been adjusted to 30% to 60% by weight, preferably to 40% to 50% by weight, based on the total amount of binder component (1).

With regard to the process parameters of pH and viscosity, the present invention embraces a pH of binder component (1) which was adjusted to 5 to 10, preferably 7 to 8; the viscosity (Brookfield, 20° C.) of binder component (1) ought to have been adjusted to 10 to 500 mPa·s and preferably 25 to 250 mPa·s. With regard to the aqueous binder component (1), it can be advantageous if the average particle diameter of the micelles of this binder component was adjusted to 10 to 500 nm and preferably 25 to 250 nm.

It is considered to be preferred if the ratio of binder component (I) to curing component (II) was 20:1 to 2:1, preferably 3:1 to 5:1.

With the proviso that the functionalized polyurethane resin of the invention has been prepared from the binder component (I) and the curing component (II), its fluorine content ought to be adjusted, in one preferred variant, to 0.01% to 10% by weight, preferably to 0.5% to 5% by weight.

Besides the functionalized polyurethane resin itself, the present invention also embraces a process for preparing it. This process is characterized in that a fluorine-modified (polymeric) hydrophobicizing and oleophobicizing component (A) is prepared by reacting

(1) 5% to 95% by weight of a (per)fluoroalkyl alcohol component (A₁) and/or of a (per)fluoroalkylalkylenamine component (A₂), composed of perfluoroalkyl alcohols having terminal methylene groups (hydrocarbon spacers) of the general formula

CF₃—(CF₂)ₓ—(CH₂)_{y}—O-A_{z}-H

and/or

CR₃—(CR₂)ₓ—(CH₂)_{y}A_{z}-H

in which R=independently of one another H, F, CF₃

and/or

hexafluoropropene oxide (HFPO) oligomer alcohols of the general formula

CF₃—CF₂—CF₂—[O—CF(CF₃)—CF₂]ₓ—O—CF(CF₃)—(CH₂)_{y}—O-A_{z}-H

in which x=3-20, y=1-6, z=0-100,

A=CRⁱRⁱⁱ—CRⁱⁱⁱR^{iv}—O or (CRⁱRⁱⁱ)ₐ—O or CO—(CRⁱRⁱⁱ)_{b}—O, Rⁱ, Rⁱⁱ, Rⁱⁱⁱ, R^{iv}=independently of one another H, alkyl, cycloalkyl, aryl, any organic radical having 1-25 C atoms; a, b=3-5, the polyalkylene oxide structural unit A, comprising homopolymers, copolymers or block copolymers of any desired alkylene oxides, or comprising polyoxyalkylene glycols or comprising polylactones,

and/or a fluorine-modified macromonomer or telechelic component (A₃) having a polymer-bonded fluorine content of 1% to 99% by weight and a molecular mass of 100 to 10 000 daltons, comprising, terminally and/or laterally and/or intrachenally in the side chain and/or main chain, the structural elements

—(CF₂—CF₂)ₓ—

and/or

—(CR₂—CR₂)ₓ—

and/or

—[CF₂—CF(CF₃)—O]ₓ—

and/or

—(CR₂—CR₂—O)ₓ—

having in each case one or more reactive (cyclo)aliphatic and/or aromatic hydroxyl groups and/or primary and/or secondary amino groups and/or mercapto groups, 75% to 5% by weight of a difunctional polyisocyanate component (C₁) having two or more (cyclo)aliphatic and/or aromatic isocyanate groups of like or different reactivity, and 75% to 5% by weight of an amino alcohol component (A₄) having a (cyclo)aliphatic and/or aromatic, primary or secondary amino group and one or more (cyclo)aliphatic and/or aromatic hydroxyl groups, and/or of a mercapto alcohol component (A₅) having a (cyclo)aliphatic and/or aromatic mercapto group and one or more (cyclo)aliphatic and/or aromatic hydroxyl groups, the reaction in the case of diisocyanates being carried out preferably in a molar ratio of 1:1:1 in any desired way, and the reaction products having the general formula

(A_{1/2/3})—(C₁)-(A_{4/5})

with (A_{1/2/3})=deprotonated components (A₁) and/or (A₂) and/or (A₃), (A_{4/5})=deprotonated components (A₄) and/or (A₅), and (C₁)=protonated component (C₁),

and/or

(2) 5% to 95% by weight of a monofunctional hexafluoropropene oxide component (A₆), composed of monofunctional hexafluoropropene oxide oligomers of the general formula

CF₃—CF₂—CF₂—O—(CF(CF₃)—CF₂—O)ₘ—CF(CF₃)—COR¹

in which m=1-20, R¹═F, OH, OMe, OEt

and 95% to 5% by weight of an amino alcohol component (A₄) and/or of a mercapto alcohol component (A₅), elimination of HR¹ producing an adduct of the general formula

(A₆)-(A_{4/5})

in which (A₆)=carbonyl radical of component (A₆)

and the reaction being carried out preferably in a molar ratio of 1:1 in any desired way,

and/or

(3) 5% to 95% by weight of a difunctional hexafluoropropene oxide component (A₇), composed of difunctional hexafluoropropene oxide oligomers of the general formula

R¹OC—CF(CF₃)—(O—CF₂—CF(CF₃))ₙ—CF₂)ₒ—O—

(CF(CF₃)—CF₂—O)ₙ—CF(CF₃)COR¹

in which n=1-10, o=2-6

and 95% to 5% by weight of an amino alcohol component (A₄) and/or of a mercapto alcohol component (A₅), elimination of HR¹ producing an adduct of the general formula

(A_{4/5})-(A₇)-(A_{4/5})

in which (A₇)=carbonyl radical of component (A₇)

and the reaction being carried out preferably in a molar ratio of 1:2 in any desired way,

and/or

(4) 5% to 95% by weight of a (per)fluoroalkyl alcohol component (A₁) and/or of a (per)fluoroalkylalkylenamine component (A₂) and/or of a fluorine-modified macromonomer or telechelic component (A₃), 75% to 5% by weight of a carbonyl component (A₈) of the general formula

X—CO—Y

in which X, Y═F, Cl, Br, I, CCl₃, R², OR², R²=alkyl, cycloalkyl, aryl, any organic radical having 1-25 C atoms, 0-10 N atoms, and 0-10 O atoms

and 75% to 5% by weight of an amino alcohol component (A₄) and/or of a mercapto alcohol component (A₅), elimination of HX and/or HY in the first stage producing an adduct of the general formula

(A_{1/2/3})—CO—Y and/or X—CO-(A_{1/2/3})

and/or

(A_{4/5})—CO—Y and/or X—CO-(A_{4/5})

and elimination of HX and/or HY in the second stage producing an adduct of the general formula

(A_{4/5})-CO-(A_{4,5})

and the reaction being carried out preferably in a molar ratio of 1:1:1 in any desired way,

or

5% to 95% by weight of a pre-prepared adduct of the general formula

(A_{1/2/3})-CO—Y and/or X—CO-(A_{1/2/3})

and 95% to 5% by weight of an amino alcohol component (A₄) and/or of a mercapto alcohol component (A₅), elimination of HX and/or HY producing an adduct of the general formula

(A_{1/2/3})-CO-(A_{4/5})

and the reaction being carried out preferably in a molar ratio of 1:1 in any desired way,

or

5% to 95% by weight of a pre-prepared adduct of the general formula

(A_{4/5})-CO—Y and/or X—CO-(A_{4/5})

and 95% to 5% by weight of a (per)fluoroalkyl alcohol component (A₁) and/or of a (per)fluoroalkylalkylenamine component (A₂) and/or of a fluorine-modified macromonomer or telechelic component (A₃), elimination of HX and/or HY producing an adduct of the general formula

(A_{1/2/3})-CO-(A_{4/5})

and the reaction being carried out preferably in a molar ratio of 1:1 in any desired way,

and/or

(5) 5% to 95% by weight of a (per)fluoroalkyl alcohol component (A₁) and/or of a (per)fluoroalkylalkylenamine component (A₂) and/or of a fluorine-modified macromonomer or telechelic component (A₃), 75% to 5% by weight of an amino alcohol component (A₄) and/or of a mercapto alcohol component (A₅), and 75% to 5% by weight of a polyisocyanate component (C₂) having a functionality of three or more, the reaction in the case of triisocyanates being carried out preferably in a molar ratio of 2:1:1 or 1:2:1 in any desired way,

and/or

(6) 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a monofunctional polyalkylene glycol component (A₉) and/or of a monofunctional polyoxyalkylenamine component (A₁₀), composed of monohydroxy-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula

R³—O-A_{z′}-H

in which z′=5-150, R³=alkyl, cycloalkyl, aryl, any organic radical having 1-25 C atoms

and/or

monoamino-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula

R³A—O-A_{z′-1}-CRⁱRⁱⁱ—CRⁱⁱⁱR^{iv}—NH₂

and 50% to 5% by weight of a polyisocyanate component (C₃) having a functionality of three or more, the reaction in the case of triisocyanates being carried out preferably in a molar ratio of 1:1:1:1 in any desired way,

and/or

(7) 5% to 95% by weight of a (per)fluoroalkyl alcohol component (A₁) and/or of a (per)fluoroalkylalkylenamine component (A₂) and/or of a fluorine-modified macromonomer or telechelic component (A₃), 75% to 5% by weight of an amino alcohol component (A₄) and/or of a mercapto alcohol component (A₅), and 75% to 5% by weight of a triazine component (A₁₁), composed of cyanuric chloride or 2,4,6-trichloro-1,3,5-triazine, the reaction being carried out preferably in a molar ratio of 2:1:1 or 1:2:1 in any desired way,

and/or

(8) 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a monofunctional polyalkylene glycol component (A₉) and/or of a monofunctional polyoxyalkylenamine component (A₁₀), and 50% to 5% by weight of a triazine component (A₁₁), composed of cyanuric chloride or 2,4,6-trichloro-1,3,5-triazine, the reaction being carried out preferably in a molar ratio of 1:1:1:1 in any desired way,

and/or

(9) 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a hydroxycarboxylic acid component (A₁₂), composed of a monohydroxycarboxylic acid and/or of a dihydroxycarboxylic acid having one and/or two polyisocyanate-reactive hydroxyl group(s) and a polyisocyanate-inert carboxyl group, and 50% to 5% by weight of a polyisocyanate component (C₃) having a functionality of three or more, the reaction in the case of triisocyanates being carried out preferably in a molar ratio of 1:1:1:1 in any desired way,

and/or

(10) 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of an NCN component (A₁₃), composed of cyanamide having a polyisocyanate-reactive and NH-acidic amino group, and 50% to 5% by weight of a polyisocyanate component (C₃) having a functionality of three or more, the reaction in the case of triisocyanates being carried out preferably in a molar ratio of 1:1:1:1 in any desired way,

and/or

(11) 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a hydroxycarboxylic acid component (A₁₂), composed of a monohydroxycarboxylic acid and/or of a dihydroxycarboxylic acid having one and/or two polyisocyanate-reactive hydroxyl group(s) and a polyisocyanate-inert carboxyl group, and 50% to 5% by weight of a triazine component (A₁₁), composed of cyanuric chloride or 2,4,6-trichloro-1,3,5-triazine, the reaction being carried out preferably in the molar ratio of 1:1:1:1 in any desired way,

and/or

(12) 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of an NCN component (A₁₂), composed of cyanamide having a polyisocyanate-reactive and NH-acidic amino group, and 50% to 5% by weight of a triazine component (A₁₁), composed of cyanuric chloride or 2,4,6-trichloro-1,3,5-triazine, the reaction being carried out preferably in a molar ratio of 1:1:1:1 in any desired way,

and/or

(13) reacting 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a low molecular mass polyol component (B₁) and/or of a hydrophobically modified low molecular mass polyol component (B₂) of an anionically modifiable and/or cationically modifiable polyol component (B₃) and/or of a nonionically hydrophilic, polymeric polyol component (B₄) and/or of a high molecular mass (polymeric) polyol component (B₅), and 50% to 5% by weight of a difunctional polyisocyanate component (C₁), the reaction being carried out preferably in a molar ratio of 1:1:1:2 in any desired way, and the reaction products having the general formula

(A_{1/2/3})-(C₁)-(B_{1/2/3/4/5})—(C₁)-(A_{4/5})

in which (B_{1/2/3/4/5})=deprotonated components (B₁) and/or (B₂) and/or (B₃) and/or (B₄) and/or (B₅),

and/or

(14) 5% to 75% by weight of a (per)fluoroalkyl alcohol component (A₁) and/or of a (per)fluoroalkylalkylenamine component (A₂) and/or of a macromonomer or telechelic component (A₃), 50% to 5% by weight of an amino alcohol component (A₄) and/or of a mercapto alcohol component (A₅), 50% to 5% by weight of a polyfunctional polyalkylene glycol component (A₁₄) and/or of a polyfunctional polyoxyalkylenamine component (A₁₅), composed of polyhydroxy-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula

R⁴(—O-A_{z′}-H)_{z″}

in which z″=2-6, R⁴=alkyl, cycloalkyl, aryl, any organic radical having 1-25 C atoms

and/or

polyamino-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula

R⁴(—O-A_{z′-1}-CRⁱRⁱⁱ—CRⁱⁱⁱR^{iv}—NH₂)_{z″}

and 50% to 5% by weight of a difunctional polyisocyanate component (C₁), the reaction in the case of difunctional polyalkylene glycols and/or polyoxyalkylenamines being carried out preferably in a molar ratio of 1:1:1:2 in any desired way, and the reaction products having the general formula

(A_{1/2/3})-(C₁)-(A_{14/15})-(C₁)-(A_{4/5})

in which (A_{14/15})=deprotonated components (A₁₄) and/or (A₁₅)

and/or

(15) 5% to 95% by weight of a (per)fluoroalkyl alcohol component (A₁) and/or of a (per)fluoroalkylalkylenamine component (A₂) and/or of a macromonomer or telechelic component (A₃) and/or of a hexafluoropropene oxide component (A₆) with R¹═OH and/or of a hexafluoropropene oxide component (A₇) with R¹═OH and/or of a (per)fluoroalkylalkanecarboxylic acid component (A₁₆) of the general formula

CF₃—(CF₂)ₓ—(CH₂)_{y}—COOH

and/or

CR₃—(CR₂)ₓ—(CH₂)_{y}—COOH,

75% to 5% by weight of an amino alcohol component (A₄) and/or of a mercapto alcohol component (A₅) of a fatty alcohol component (A₁₇) having one or more hydroxyl groups, and/or of an (un)saturated fatty amine component (A₁₈) having one or more amino groups, and/or of a fatty acid component (A₁₉) having one or more carboxyl groups, and 75% to 5% by weight of an epoxide component (A₂₀) having two or more epoxide groups, the reaction being carried out preferably in a molar ratio of 1:1:1 in any desired way, and the reaction products having the general formula

(A_{1/2/3/6/7/16})-CH₂—CH(OH)—R⁵—CH(OH)—CH₂-(A_{4/5/17/18/19})

and/or

HO—CH₂—CH((A_{1/2/3/6/7/16})—R⁵—CH((A_{4/5/17/18/19}))—CH₂—OH

and/or

(A_{1/2/3/6/7/16})—CH₂—CH(OH)—R⁵—CH((A_{4/5/17/18/19})—CH₂—OH

and/or

HO—CH₂—CH((A_{1/2/3/6/7}))—R⁵—CH(OH)—CH₂-(A_{4/5/17/18/19})

in which (A_{1/2/3/6/7/16})=deprotonated components (A₆) and/or (A₇) and/or (A₁₆), (A_{4/5/17/18/19})=deprotonated components (A₁₇) and/or (A₁₈) and/or (A₁₉), R⁵=alkyl, cycloalkyl, aryl, any organic radical having 2-50 C atoms and 0-25 O atoms and 0-25 N atoms,

and/or

(16) 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a polyisocyanate component (C₃) modified with uretdione groups, and 75% to 5% by weight of an amino alcohol component (A₄) and/or of a mercapto alcohol component (A₅), the reaction being carried out preferably in a molar ratio of 2:1.2 in any desired way,

and/or

(17) 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a polyisocyanate component (C₂) having a functionality of three or more, the reaction being carried out preferably in a molar ratio of 1:1 in any desired way,

and/or

(18) reacting 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of an amino alcohol component (A₄) and/or of a mercapto alcohol component (A₅), and 75% to 5% by weight of a polyisocyanate component (C₄) modified with sodium sulfonate groups, the reaction being carried out preferably in a molar ratio of 1:1:1 in any desired way,

and/or

(19) 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a monoisocyanate component (C₅) modified with unsaturated groups, and 75% to 5% by weight of an amino alcohol component (A₄) and/or of a mercapto alcohol component (A₅), the reaction being carried out preferably in a molar ratio of 1:1:1 in any desired way,

and/or

(20) 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a monoisocyanate component (C₆) modified with ester groups, and 75% to 5% by weight of an amino alcohol component (A₄) and/or of a mercapto alcohol component (A₅), the reaction being carried out preferably in a molar ratio of 1:1:1 in any desired way,

and/or

(21) 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a difunctional polyisocyanate component (C₁), 75% to 5% by weight of a hydroxy-functional (un)saturated triglyceride component (A₂₁) having two or more hydroxyl groups, the reaction being carried out preferably in a molar ratio of 1:1:1 in any desired way,

and/or

(22) 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a hydroxy- and epoxy-functional (un)saturated triglyceride component (A₂₂) having one or more hydroxyl groups and/or one or more epoxy groups, the reaction being carried out preferably in a molar ratio of 1:1 in any desired way,

and/or

(23) 5% to 95% by weight of a (per)fluoroalkylalkylene oxide component (A₂₃) of the general formula

CF₃—(CF₂)ₓ—(CH₂)_{y}—CHOCH₂

and/or

CR₃—(CR₂)ₓ—(CH₂)_{y}—CHOCH₂

and/or

CR₃—(CR₂)ₓ—(CH₂)_{y}—O—CH₂—CHOCH₂

and 95% to 5% by weight of an amino alcohol component (A₄) and/or of a mercapto alcohol component (A₅), the reaction being carried out preferably in a molar ratio of 1:1 in any desired way,

and/or

(24) 5% to 95% by weight of a (per)fluoroalkylalkylene oxide component (A₂₃) and 95% to 5% by weight of a chain extender or chain terminator component (E), the reaction in the case of monoamines with a primary amino group being carried out preferably in a molar ratio of 2:1, in the case of diamines with two primary amino groups, preferably in a molar ratio of 4:1, in the case of diamines with a primary and a secondary amino group, preferably in a molar ratio of 3:1, and, in the case of diamines with a primary and a secondary amino group, preferably in a molar ratio of 2:1, in any desired way,

and/or

(25) 5% to 95% by weight of a (per)fluoroalkylalkylene oxide component (A₂₃), 75% to 5% by weight of a difunctional polyisocyanate component (C₁), and 75% to 5% by weight of an amino alcohol component (A₄) and/or of a mercapto alcohol component (A₅), with oxazolidone structures being formed, and the reaction being carried out preferably in a molar ratio of 1:1:1 in any desired way,

and/or

(26) 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a hydroxy-functional epoxide component (A₂₄) having one or more hydroxyl groups and/or one or more epoxy groups, and/or of a hydroxy-functional oxetane component (A₂₅) having one or more hydroxyl groups and/or one or more oxetane groups, the reaction being carried out preferably in a molar ratio of 1:1 in any desired way,

and/or

(27) 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a hydroxy-functional cyclopropane component (A₂₆) having one or more hydroxyl groups and/or one or more epoxy groups, and/or of a hydroxy-functional cyclobutane component (A₂₇) having one or more hydroxyl groups and/or one or more oxetane groups, the reaction being carried out preferably in a molar ratio of 1:1 in any desired way,

and/or

(28) 5% to 75% by weight of a (per)fluoroalkyl alcohol component (A₁) and/or of a (per)fluoroalkylalkylenamine component (A₂) and/or of a macromonomer or telechelic component (A₃), 50% to 5% by weight of a difunctional polyisocyanate component (C₁), 50% to 5% by weight of a hydroxy-functional lactone component (A₂₈), and 50% to 5% by weight of an amino alcohol component (A₄) and/or of a mercapto alcohol component (A₅), the reaction being carried out preferably in a molar ratio of 1:1:1:1 in any desired way,

and/or

(29) 5% to 95% by weight of a fluorine-modified (meth)acrylate component (A₂₉) and 95% to 5% by weight of an amino alcohol component (A₄) and/or of a mercapto alcohol component (A₅), the reaction being carried out preferably in a molar ratio of 1:1 in any desired way,

and/or

(30) 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a latent curing component (A₃₀) having a primary or secondary amino groups reactive toward isocyanate groups, or having a hydroxyl groups reactive toward isocyanate groups and having one or more hydroxyl groups and/or primary and/or secondary amino groups that are blocked and/or latently reactive toward isocyanate groups, and 75% to 5% by weight of water, first of all components (A₁) and/or (A₂) and/or (A₃) and (A₃₀) being reacted in the first stage, the adduct from the first stage and the water being reacted in the second stage, and any cleavage products liberated being removed in the third stage, and the reaction being carried out preferably in a molar ratio of 1:1:1 in any desired way,

and/or

(31) 5% to 95% by weight of a (per)fluoroalkylalkylene isocyanate component (A₃₁) of the general formula

CF₃—(CF₂)ₓ—(CH₂)_{y}—NCO

and/or

CR₃—(CR₂)ₓ—(CH₂)_{y}NCO

and 95% to 5% by weight of an amino alcohol component (A₄) and/or of a mercapto alcohol component (A₅), an adduct of the general formula

(A₃₁)-(A_{4/5})

in which (A₃₁)=protonated component (A₃₁)

being obtained and the reaction being carried out preferably in a molar ratio of 1:1 in any desired way,

and/or

(32) 5% to 95% by weight of a (per)fluoroalkylalkanecarboxylic acid derivative component (A₃₂) of the general formula

CF₃—(CF₂)ₓ—(CH₂)_{y}—COR⁶

and/or

CR₃—(CR₂)ₓ—(CH₂)_{y}COR⁶

with R⁶=Cl, OMe, OEt

and 95% to 5% by weight of an amino alcohol component (A₄) and/or of a mercapto alcohol component (A₅), elimination of HR⁶ producing an adduct of the general formula

(A₃₂)-(A_{4/5})

in which (A₃₂)=carbonyl radical of component (A₃₂)

and the Reaction being Carried Out Preferably in a Molar Ratio of 1:1 in any desired way,

and/or

(33) replacing the (per)fluoroalkyl alcohol component (A₁) and/or the (per)fluoroalkylalkylenamine component (A₂) and/or the macromonomer or telechelic component (A₃) by the (per)fluoroalkylalkanecarboxylic acid component (A₃₂) in the case of the reaction products of (1), (5), (6), (9), (10), (13), (14), (16)-(22), amide structures being obtained, with elimination of CO₂,

and/or

(34) alkoxylating reaction products of (1) to (16) and (18) to (33), the alkoxylated reaction products having the general formula

(U)-(A_{z′}-H)_{z″}

in which (U)=deprotonated reaction products (1) to (16) and (18) to (33),

and/or

(35) using a polyhedral oligomeric polysilasesquioxane component (A₃₃) of the general formula

(R⁷ᵤR⁸ᵥR⁹_{w}SiO_{1.5})ₚ

in which 0<u<1, 0<v<1, 0<w<1, u+v+w=1, p=4, 6, 8, 10, 12, and R⁷, R⁸, R⁹=independently of one another any inorganic and/or organic and optionally polymeric radical having 1-250 C atoms and 1-50 N and/or 0-50 O and/or 3-100 F and/or 0-50 Si and/or 0-50 S atoms,

the reaction of the respective reaction components taking place by single-stage or multistage (poly)addition reactions (and elimination reactions) and optionally in the presence of solvents and/or catalysts of any kind.

For preparing the fluorine-modified (polymeric) hydrophobicizing and oleophobicizing component (A) as per (1), in stage

(1a) components (A₁) and/or (A₂) and/or (A₃) are reacted with component (C₁) optionally in the presence of components (G) and (H), the components (A₁) and/or (A₂) and/or (A₃) preferably being added to component (C₁),

(1b) the preadduct from stage (1a) is reacted with components (A₄) and/or (A₅) optionally in the presence of components (G) and (H), the preadduct from stage (1a) preferably being added to components (A₄) and/or (A₅),

the reactions of stages (1a) and (1b) being carried out in two separate reactors or in one reactor and being controlled in such a way as to produce 50%-95%, preferably 70%-95%, and more preferably 90%-95%, by weight, of principal product of the general formula

(A_{1/2/3})-(C₁)-(A_{4/5})

and also 50%-5%, preferably 30%-5%, and more preferably less than 10%-5%, by weight, of substantial byproducts of the general formulae

(A_{1/2/3})-(C₁)-(A_{1/2/3})

and/or

(A_{4/5})-(C₁)-(A_{4/5})

and/or

(A_{1/2/3})-(C₁)-(A_{4/5})-(C₁)-(A_{1/2/3})

and/or

(A_{1/2/3})-(C₁)-(A_{4/5})-(C₁)-(A_{4/5})

and/or

(A_{4/5})-(C₁)-(A_{4/5})-(C₁)-(A_{4,5})

and/or higher oligomers.

For preparing the nonionically hydrophilically polymeric polyol component (B₄), in stage

(i) components (A₉) and/or (A₁₀) are reacted with component (C₁) optionally in the presence of components (G) and (H), the components (A₉) and/or (A₁₀) preferably being added to component (C₁),

(ii) the preadduct from stage (i) is reacted with components (A₄) and/or (A₅) optionally in the presence of components (G) and (H), the preadduct from stage (1a) preferably being added to components (A₄) and/or (A₅),

the reactions of stages (i) and (ii) being carried out in two separate reactors or in one reactor and being controlled in such a way as to produce 50%-95%, preferably 70%-95%, and more preferably 90%-95%, by weight, of principal product of the general formula

(A_{9/10})-(C₁)-(A_{4/5})

and also 50%-5%, preferably 30%-5%, and more preferably less than 10%-5%, by weight, of substantial byproducts of the general formulae

(A_{9/10})-(C₁)-(A_{9/10})

and/or

(A_{4/5})-(C₁)-(A_{4/5})

and/or

(A_{9/10})-(C₁)-(A_{4/5})-(C₁)-(A_{9/10})

and/or

(A_{9/10})-(C₁)-(A_{4/5})-(C₁)-(A_{4/5})

and/or

(A_{4/5})-(C₁)-(A_{4/5})-(C₁)-(A_{4/5})

and/or higher oligomers.

With a further variant, the present invention covers the use of the functionalized polyurethane resin for producing a fluorine-modified polyurethane coating. This use is characterized in that in stage

a) a binder component (1) is prepared by, in stage

a₁) reacting, or carrying out polyaddition of, components (A₁) to (A₃₃), (B₁) to (B₅), and (C₁) to (C₆) in any desired way to give a component (A), components (G) and (H) being optionally present,

then in stage

a_{2.1.1}) reacting, or carrying out polyaddition of, components (A) and (C) to give a preadduct, components (G) and (H) being optionally present,

then in stage

a_{2.1.2}) optionally reacting, or carrying out polyaddition of, the isocyanato-functional preadduct from stage a_{2.1.1}) with component (B₄) to give a preadduct, components (G) and (H) being optionally present,

then in stage

a_{2.1.3}) reacting, or carrying out polyaddition of, the isocyanato-functional preadduct from stage a_{2.1.1}) or a_{2.1.2}) with components (B₁), (B₂), and (B₅) to give a preadduct or isocyanato-functional oligourethane or polyurethane prepolymer, components (G) and (H) being optionally present,

then in stage

a_{2.1.4}) optionally reacting, or carrying out polyaddition of, the isocyanato-functional preadduct from stage a_{2.1.3}) with component (B₃) to give an isocyanato-functional oligourethane or polyurethane prepolymer, components (G) and (H) being optionally present,

or

a_{2.2.1}) reacting, or carrying out polyaddition of, component (C) with 10%-90% by weight of a pre-prepared mixture of components (A) and (B) to give a preadduct, components (G) and (H) being optionally present,

and then

a_{2.2.2}) reacting, or carrying out polyaddition of, the preadduct from stage a_{2.2.1}) with 90%-10% of a pre-prepared mixture of components (A) and (B) to give an oligourethane or polyurethane prepolymer, components (G) and (H) being optionally present

or

a_{2.3}) reacting, or carrying out polyaddition of, components (A), (B), and (C) in one or more stages to give an isocyanato-functional oligourethane or polyurethane prepolymer, components (G) and (H) being optionally present

and subsequently

a₃) optionally reacting the isocyanato-functional oligourethane or polyurethane prepolymer from stages a_{2.1.3}) or a_{2.1.4}) or a_{2.2.2}) or a_{2.3}) with component (E), components (G) and (H) being optionally present,

then in stage

a₄) optionally reacting, or directly neutralizing, the amino- and/or hydroxy- or isocyanato-functional oligourethane or polyurethane prepolymer from stages a_{2.1.3}) or a_{2.1.4}) or a_{2.2.2}) or a_{2.3}) or a₃) with component (D),

then in stage

a₅) overlayering the (neutralized) amino- and/or hydroxy- or isocyanato-functional oligourethane or polyurethane prepolymer from stages a_{2.1.3}) or a_{2.4}) or a_{2.2.2}) or a_{2.3}) or a₃) or a₄) with component (1) and dispersing the mixture,

then in stage

a₆) optionally reacting, or carrying out polyaddition of, the (neutralized) oligourethane or polyurethane predispersion or solution from stage a₅) with component (E),

then in stage

a₇) optionally partly or completely freeing the oligourethane or polyurethane prepolymer dispersion or solution from component (G) by redistillation,

then in stage

b) optionally the binder component (I) from stage a) is reacted with the curing component (II), and finally in stage

c) a fluorine-modified polyurethane coating is produced by applying the coating system obtained from stages a) or b) to any desired substrate,

and, optionally, in stages a) to c), component (F) is reacted as well in any desired way and the formulating component (III) is also present.

In this context the reaction in stages a₁) to a₆) ought to be carried out partly or completely, with preference being given to its full implementation. Also, in stage a₆), it is possible for any free isocyanate groups still present to be consumed by reaction with component (I). Alternatively to stage a₅) it is possible to disperse the (neutralized) amino- and/or hydroxy- or isocyanato-functional oligourethane or polyurethane prepolymer from stages a_{2.1.3}) or a_{2.1.4}) or a_{2.2.2}) or a_{2.3}) or a₃) or a₄) into component (I) in any desired way, or to disperse component (I) into these prepolymers.

Likewise alternatively, in accordance with the present invention, to stages a₄) and a₅), the component (D) can be introduced as an initial charge in component (I) in any desired way.

Provision is further made for stage a₁) to be carried out at a temperature at 40 to 200° C. and preferably at 60 to 180° C., with stages a₂), a₃), and a₄) being carried out preferably at a temperature of 40 to 120° C. and preferably at 80 to 100° C. For stages a₅) and a₆) a temperature of 20 to 60° C. and preferably 30 to 50° C. is envisaged.

With regard to stages b) and c), the present invention envisages temperatures of 10 to 50° C. and preferably 20 to 40° C.

The invention further relates to the use of the functionalized polyurethane resin in the construction or industrial sector for the permanent oil-, water- and dirt-repellent coating of mineral and nonmineral surfaces based on cement (concrete, mortar), lime, gypsum, anhydrite, geopolymers, clay, enamel, woven fabric and textiles, glass, rubber, wood and woodbase materials, artificial stone and natural stone, real and synthetic leather, ceramic, plastic and glass fiber-reinforced plastic (GRP), metals and metal alloys, paper, polymers or composite materials.

The functionalized polyurethane resin can be used in the construction or industrial sector for producing oil-, water-, and dirt-repellent coating systems in the applications of
paints and varnishes of any kind
coating systems of any kind
a sealing systems of any kind.

The functionalized polyurethane resin is suitable, moreover, for use in the construction or industrial sector for producing oil-, water-, and dirt-repellent coating systems in the applications of
antigraffiti coatings
antisoiling coatings
easy-to-clean coatings
low dirt pickup coatings
agents for antigraffiti coatings
agents for antisoiling coatings
agents for easy-to-clean coatings
agents for low dirt pickup coatings
surfaces with Lotus-Effect®.

Furthermore, the functionalized polyurethane resin can be used in the construction or industrial sector for producing oil-, water-, and dirt-repellent coating systems in the applications of
a balcony coatings
floor coatings
coil coatings
roof (shingle) coatings
baking varnishes
coatings for architectural facings
masonry paints
woven-fabric and textile coatings
wood and furniture coatings
industrial floors
leather dressing
surface modification of fillers, nanoparticles, and pigments
paper coating
parquet floor coatings
PCC coating systems
crack-bridging coating systems
rotor blade coatings (wind turbines)
marine paints
sports ground surfacing systems,

and also in the construction or industrial sector for producing oil-, water-, and dirt-repellent coating systems in the applications of
seals
a architectural preservation
corrosion control
tiles and joints
adhesives and sealants
plasters and decorative renders
exterior insulation and finishing systems (EIFS) and exterior insulation systems (EIS).

Provision is likewise made for the functionalized polyurethane resin to be used, additionally, in the construction or industrial sector for the permanent oil-, water-, and dirt-repellent coating and/or mass hydrophobicizing/oloophobicizing of concrete, such as
job-mix concrete
concrete products (precast concrete parts, concrete ware, cast concrete stones)
poured-in-place concrete
air-placed concrete
ready-mix concrete.

The functionalized polyurethane resin can be applied without problems in one- or two-component form to the substrates to be coated. In the case of one-component application, the binder component (I) is used alone; in the case of two-component application, the binder component (I) is used in combination with the curing component (II).

The functionalized polyurethane resin can be applied at an application rate of 1 to 1000 g/m² to the substrates to be coated, and/or in a coat thickness of 1 to 1000 μm.

Additionally, the functionalized polyurethane resin according to the invention can be used in any desired combination with conventional binders of any kind and/or formulations produced therefrom.

Supplementarily it is possible to use the functionalized polyurethane resin in any desired combination with conventional binders of any kind and/or formulations produced therefrom, in the applications of
primer
1st topcoat
2nd topcoat
sealant.

Provision is likewise made for the functionalized polyurethane resin to be used in any desired combination with conventional binders of any kind and/or formulations produced therefrom, in the applications of
repair
retopping
mixed system construction.

The application of the polyurethane resin of the invention takes place customarily by the methods known from paint and coating technology, such as flow coating, pouring, knifecoating, roller coating, spraying, brushing, dipping and rolling, for example.

The examples which follow are intended to illustrate the invention in more detail.

### EXAMPLES

### Example A

### Fluorine-Modified Intermediates

### Example A.1

A four-necked flask equipped with KPG stirrer, air condenser, internal thermometer, and nitrogen tap was charged under nitrogen blanketing with 503.23 g of isophorone diisocyanate (Vestanat® IPDI, Degussa) and 0.20 g of dibutyltin dilaurate (Aldrich) and this initial charge was preheated to 40° C. Then 1000.00 g of a perfluoroalkyl alcohol with an OHN of 127 mgKOH/g (Fluowet® EA 612, Clariant) at 60° C. were added dropwise, with thorough stirring and with cooling, at a rate such that the internal temperature did not exceed 80° C. This was followed by stirring at 80° C. for about 1 h. When the theoretical NCO value was reached, a mixture of 238.04 g of diethanolamine (BASF) and 426.62 g of N-ethylpyrrolidone (BASF) at room temperature was added dropwise, with thorough stirring and with cooling, at a rate such that the internal temperature did not exceed 80° C. This was followed by further stirring at 80-60° C. for about 1 h, and the resin was then discharged.

| | |
|---|---|
| Appearance | yellowish resin |
| OHN (solution) | 117 mgKOH/g |
| Molar mass (solid resin) | 766 daltons |
| Solids content | 80% by weight |
| Solvent content | 20% by weight |

### Example A.2

### Procedure as for Example A.1

2000.00 g of isophorone diisocyanate were used (excess). Following stage 1, the excess isophorone diisocyanate was stripped off using a thin-film evaporator.

| | |
|---|---|
| Appearance | yellowish resin |
| OHN (solution) | 117 mgKOH/g |
| Molar mass (solid resin) | 766 daltons |
| Solids content | 80% by weight |
| Solvent content | 20% by weight |

### Example A.3

A four-necked flask equipped with KPG stirrer, air condenser, internal thermometer, and nitrogen tap was charged under nitrogen blanketing with 503.23 g of isophorone diisocyanate (Vestanat® IPDI, Degussa) and 0.20 g of dibutyltin dilaurate (Aldrich) and this initial charge was preheated to 40° C. Then 1000.00 g of a perfluoroalkyl alcohol with an OHN of 127 mgKOH/g (Fluowet® EA 612, Clariant) at 60° C. were added dropwise, with thorough stirring and with cooling, at a rate such that the internal temperature did not exceed 80° C. This was followed by stirring at 80° C. for about 1 h. When the theoretical NCO value was reached, a mixture of 301.52 g of diisopropanolamine (BASF) and 442.49 g of N-ethylpyrrolidone (BASF) at room temperature was added dropwise, with thorough stirring and with cooling, at a rate such that the internal temperature did not exceed 80° C. This was followed by further stirring at 80-60° C. for about V2 h, and the resin was then discharged.

| | |
|---|---|
| Appearance | yellowish resin |
| OHN (solution) | 113 mgKOH/g |
| Molar mass (solid resin) | 794 daltons |
| Solids content | 80% by weight |
| Solvent content | 20% by weight |

### Example A.4

A four-necked flask equipped with KPG stirrer, air condenser, internal thermometer, and nitrogen tap was charged under nitrogen blanketing with 178.28 g of an isocyanurate based on hexane 1,6-diisocyanate, with an equivalent weight of 175 daltons (Desmodur® XI 2410, Bayer) and 0.02 g of dibutyltin dilaurate (Aldrich) and this initial charge was preheated to 40° C. Then 150.00 g of a perfluoroalkyl alcohol with an OHN of 127 mgKOH/g (Fluowet® EA 612, Clariant) at 60° C. were added dropwise, with thorough stirring and with cooling, at a rate such that the internal temperature did not exceed 80° C. This was followed by stirring at 80° C. for about 1 h. When the theoretical NCO value was reached, a mixture of 51.01 g of isopropanolamine (BASF) and 94.83 g of N-ethylpyrrolidone (BASF) at room temperature was added dropwise, with thorough stirring and with cooling, at a rate such that the internal temperature did not exceed 80° C. This was followed by further stirring at 80-60° C. for about ½ h, and the resin was then discharged.

| | |
|---|---|
| Appearance | yellowish resin |
| OHN (solution) | 80 mgKOH/g |
| Molar mass (solid resin) | 1117 daltons |
| Solids content | 80% by weight |
| Solvent content | 20% by weight |

### Example A.5

A four-necked flask equipped with KPG stirrer, air condenser, internal thermometer, and nitrogen tap was charged under nitrogen blanketing with 621.42 g of an isocyanurate based on hexane 1,6-diisocyanate, with an equivalent weight of 183 daltons (Desmodur® N 3600, Bayer) and 0.20 g of dibutyltin dilaurate (Aldrich) and this initial charge was preheated to 40° C. Then 500.00 g of a perfluoroalkyl alcohol with an OHN of 127 mgKOH/g (Fluowet® EA 612, Clariant) at 60° C. were added dropwise, with thorough stirring and with cooling, at a rate such that the internal temperature did not exceed 80° C. This was followed by stirring at 80° C. for about 1 h. Thereafter, 565.96 g of a methylpolyethylene glycol with an OHN of 112.5 mgKOH/g (M 500, Clariant) at room temperature were added dropwise, with thorough stirring and with cooling, at a rate such that the internal temperature did not exceed 80° C. This was followed by stirring at 80° C. for about 1 h. When the theoretical NCO value was reached, a mixture of 119.02 g of diethanolanine (BASF) and 447.27 g of N-ethylpyrrolidone (BASF) at room temperature was added dropwise, with thorough stirring and with cooling, at a rate such that the internal temperature did not exceed 80° C. This was followed by further stirring at 80-60° C. for about ½ h, and the resin was then discharged.

| | |
|---|---|
| Appearance | yellowish resin |
| OHN (solution) | 56 mgKOH/g |
| Molar mass (solid resin) | 1593 daltons |
| Solids content | 80% by weight |
| Solvent content | 20% by weight |

### Example A.6

A four-necked flask equipped with KPG stirrer, air condenser, internal thermometer, and nitrogen tap was used for reaction under nitrogen blanketing of 503.23 g of isophorone diisocyanate (Vestanat® IPDI, Degussa), 260.78 g of tetradecane-1,2-diol (Nitrochemie Aschau), and 0.20 g of dibutyltin dilaurate (Aldrich) at 70° C. over the course of 1.5 h with thorough stirring. After cooling to 50° C., 500.00 g of a perfluoroalkyl alcohol with an OHN of 127 mSKOH/g (Fluowet® EA 612, Clariant) at 60° C. were added dropwise, with thorough stirring and with cooling, at a rate such that the internal temperature did not exceed 80° C. This was followed by stirring at 80° C. for about 4 h. When the theoretical NCO value was reached, a mixture of 119.02 g of diethanolamine (BASF) and 341.43 g of N-ethylpyrrolidone (BASF) at room temperature was added dropwise, with thorough stirring and with cooling, at a rate such that the internal temperature did not exceed 80° C. This was followed by further stirring at 80° C. for about Y2 h, and the resin was then discharged.

| | |
|---|---|
| Appearance | yellowish resin |
| OHN (solution) | 74 mgKOH/g |
| Molar mass (solid resin) | 1219 daltons |
| Solids content | 80% by weight |
| Solvent content | 20% by weight |

### Example A.7

A four-necked flask equipped with KPG stirrer, air condenser, internal thermometer, and nitrogen tap was used for reaction under nitrogen blanketing of 503.23 g of isophorone diisocyanate (Vestanat® IPDI, Degussa), 324.29 g of octadecane-1,2-diol (Nitrochemie Aschau), and 0.20 g of dibutyltin dilaurate (Aldrich) at 70° C. over the course of 1.5 h with thorough stirring. After cooling to 50° C., at 500.00 g of a perfluoroalkyl alcohol with an OHN of 127 mgKOH/g (Fluowet® EA 612, Clariant) at 60° C. were added dropwise, with thorough stirring and with cooling, at a rate such that the internal temperature did not exceed 80° C. This was followed by stirring at 80° C. for about 4 h. When the theoretical NCO value was reached, a mixture of 119.02 g of diethanolamine (BASF) and 357.31 g of N-ethylpyrrolidone (BASF) at room temperature was added dropwise, with thorough stirring and with cooling, at a rate such that the internal temperature did not exceed 80° C. This was followed by further stirring at 80° C. for about ½ h, and the resin was then discharged.

| | |
|---|---|
| Appearance | yellowish resin |
| OHN (solution) | 70 mgKOH/g |
| Molar mass (solid resin) | 1275 daltons |
| Solids content | 80% by weight |
| Solvent content | 20% by weight |

### Example B

### Flourine-Modified Polyurethane Dispersions

### Example B.1

In a four-necked flask equipped with KPG stirrer, air condenser, internal thermometer, and nitrogen tap, a mixture of 94.34 g of isophorone diisocyanate (Vestanat® IPDI, Degussa), 18.50 g of fluorine-modified intermediate from Example A.1, 0.1 g of dibutyltin dilaurate (Aldrich), and 25.00 g of N-ethylpyrrolidone (BASF) was stirred under nitrogen blanketing at 60-70° C. for 2 h. Following addition of 100.00 g of a polycarbonate diol with an OHN of 56.1 mgKOH/g (Desmophen® C1200, Bayer) and 7.50 g of butane-1,4-diol (BASF) to the preadduct, the mixture was stirred further with nitrogen blanketing at 80-90° C. for 1.5 h. Following further addition of 9.50 g of dimethylolpropionic acid (GEO Specialty Chemicals) to the preadduct, the mixture was stirred further under nitrogen blanketing at 80-90° C. for 2 h until the calculated NCO content was reached (theory: 6.63% by weight). The prepolymer was then cooled to 70° C., neutralized with 6.45 g of triethylamine (BASF), overlayered with 305.84 g of water, dispersed, and then chain-extended with 38.66 g of ethylenediamine (25% by weight in water, BASF). This gave a stable, fluorine-modified polyurethane dispersion.

| | |
|---|---|
| Appearance | semi translucent liquid |
| Solids content | 40% by weight |
| Solvent content | 4.74% by weight |

### Example B.2

Procedure as for Example B.1

18.50 g of the fluorine-modified intermediate from Example A.2 were used.

| | |
|---|---|
| Appearance | semitranslucent liquid |
| Solids content | 40% by weight |
| Solvent content | 4.74% by weight |

### Example B.3

In a four-necked flask equipped with KPG stirrer, air condenser, internal thermometer, and nitrogen tap, a mixture of 94.05 g of isophorone diisocyanate (Vestanat® IPDI, Degussa), 18.50 g of fluorine-modified intermediate from Example A.3, 0.10 g of dibutyltin dilaurate (Aldrich), and 25.00 g of N-ethylpyrrolidone (BASF) was stirred under nitrogen blanketing at 60-70° C. for 2 h. Following addition of 100.00 g of a polycarbonate diol with an OHN of 56.1 mgKOH/g (Desmophen® C1200, Bayer) and 7.50 g of butane-1,4-diol (BASF) to the preadduct, the mixture was stirred further with nitrogen blanketing at 80-90° C. for 1.5 h. Following further addition of 9.50 g of dimethylolpropionic acid (GEO Specialty Chemicals) to the preadduct, the mixture was stirred further under nitrogen blanketing at 80-90° C. for 2 h until the calculated NCO content was reached (theory: 6.61% by weight). The prepolymer was then cooled to 70° C., neutralized with 6.45 g of triethylamine (BASF), overlayered with 305.45 g of water, dispersed, and then chain-extended with 38.54 g of ethylenediamine (25% by weight in water, BASF). This gave a stable, fluorine-modified polyurethane dispersion.

| | |
|---|---|
| Appearance | semitranslucent liquid |
| Solids content | 40% by weight |
| Solvent content | 4.74% by weight |

### Example B.4

In a four-necked flask equipped with KPG stirrer, air condenser, internal thermometer, and nitrogen tap, a mixture of 96.15 g of isophorone diisocyanate (Vestanat® IPDI, Degussa), 27.75 g of fluorine-modified intermediate from Example A.4, 0.10 g of dibutyltin dilaurate (Aldrich), and 25.00 g of N-ethylpyrrolidone (BASF) was stirred under nitrogen blanketing at 60-70° C. for 2 h. Following addition of 100.00 g of a polycarbonate diol with an OHN of 56.1 mgKOH/g (Desmophen® C1200, Bayer) and 7.50 g of butane-1,4-diol (BASF) to the preadduct, the mixture was stirred further with nitrogen blanketing at 80-90° C. for 1.5 h. Following further addition of 10.00 g of dimethylolpropionic acid (GEO Specialty Chemicals) to the preadduct, the mixture was stirred further under nitrogen blanketing at 80-90° C. for 2 h until the calculated NCO content was reached (theory: 6.46% by weight). The prepolymer was then cooled to 70° C., neutralized with g of triethylamine (BASF), overlayered with 318.78 g of water, dispersed, and then chain-extended with 39.40 g of ethylenediamine (25% by weight in water, BASF). This gave a stable, fluorine-modified polyurethane dispersion.

| | |
|---|---|
| Appearance | semitranslucent liquid |
| Solids content | 40% by weight |
| Solvent content | 4.84% by weight |

### Example B.5

In a four-necked flask equipped with KPG stirrer, air condenser, internal thermometer, and nitrogen tap, a mixture of 56.54 g of isophorone diisocyanate (Vestanat® IPDI, Degussa), 18.50 g of fluorine-modified intermediate from Example A.5, 0.10 g of dibutyltin dilaurate (Aldrich), and 17.00 g of N-ethylpyrrolidone (BASF) was stirred under nitrogen blanketing at 60-70° C. for 2 h. Following addition of 100.00 g of a polycarbonate diol with an OHN of 56.1 mgKOH/g (Desmopheno C1200, Bayer) and 1.75 g of butane-1,4-diol (BASF) to the preadduct, the mixture was stirred further with nitrogen blanketing at 80-90° C. for 1.5 h. Following further addition of 6.50 g of dimethylolpropionic acid (GEO Specialty Chemicals) to the preadduct, the mixture was stirred further under nitrogen blanketing at 80-90° C. for 2 h until the calculated NCO content was reached (theory: 5.33% by weight). The prepolymer was then cooled to 70° C., neutralized with 3.68 g of triethylamine (BASF), overlayered with 192.54 g of water, dispersed, and then chain-extended with 24.46 g of ethylenediamine (25% by weight in water, BASF). This gave a stable, fluorine-modified polyurethane dispersion.

| | |
|---|---|
| Appearance | semitranslucent liquid |
| Solids content | 45% by weight |
| Solvent content | 4.92% by weight |

### Example B.6

In a four-necked flask equipped with KPG stirrer, air condenser, internal thermometer, and nitrogen tap, a mixture of 98.45 g of isophorone diisocyanate (Vestanat® IPDI, Degussa), 30.00 g of fluorine-modified intermediate from Example A.6, 0.10 g of dibutyltin dilaurate (Aldrich), and 25.00 g of N-ethylpyrrolidone (BASF) was stirred under nitrogen blanketing at 60-70° C. for 2 h. Following addition of 100.00 g of a polycarbonate diol with an OHN of 56.1 mgKOH/g (Desmophen® C1200, Bayer) and 8.00 g of butane-1,4-diol (BASF) to the preadduct, the mixture was stirred further with nitrogen blanketing at 80-90° C. for 1.5 h. Following further addition of 11.75 g of dimethylolpropionic acid (GEO Specialty Chemicals) to the preadduct, the mixture was stirred further under nitrogen blanketing at 80-90° C. for 2 h until the calculated NCO content was reached (theory: 6.05% by weight). The prepolymer was then cooled to 70° C., neutralized with 7.98 g of triethylamine (BASF), overlayered with 330.23 g of water, dispersed, and then chain-extended with 37.86 g of ethylenediamine (25% by weight in water, BASF). This gave a stable, fluorine-modified polyurethane dispersion.

| | |
|---|---|
| Appearance | semitranslucent liquid |
| Solids content | 40% by weight |
| Solvent content• | 4.77% by weight |

### Example B.7

In a four-necked flask equipped with KPG stirrer, air condenser, internal thermometer, and nitrogen tap, a mixture of 98.11 g of isophorone diisocyanate (Vestanat® IPDI, Degussa), 30.00 g of fluorine-modified intermediate from Example A.7, 0.10 g of dibutyltin dilaurate (Aldrich), and 25.00 g of N-ethylpyrrolidone (BASF) was stirred under nitrogen blanketing at 60-70° C. for 2 h. Following addition of 100.00 g of a polycarbonate diol with an OHN of 56.1 mgKOH/g (Desmophen® C 1200, Bayer) and 8.00 g of butane-1,4-diol (BASF) to the preadduct, the mixture was stirred further with nitrogen blanketing at 80-90° C. for 1.5 h. Following further addition of 11.75 g of dimethylolpropionic acid (GEO Specialty Chemicals) to the preadduct, the mixture was stirred further under nitrogen blanketing at 80-90° C. for 2 h until the calculated NCO content was reached (theory: 6.04% by weight). The prepolymer was then cooled to 70° C., neutralized with 7.98 g of triethylamine (BASF), overlayered with 329.76 g of water, dispersed, and then chain-extended with 37.72 g of ethylenediamine (25% by weight in water, BASF). This gave a stable, fluorine-modified polyurethane dispersion.

| | |
|---|---|
| Appearance | semitranslucent dispersion |
| Solids content | 38% by weight |
| Solvent content | 4.78% by weight |

### LISTING OF COMPONENTS

(I) binder component
(A) fluorine-modified (polymeric) hydrophobicizing and oleophobicizing component
(A₁) (per)fluoroalkyl alcohol component
(A₂) (per)fluoroalkylalkylenamine component
(A₃) fluorine-modified macromonomers or telechelic component
(A₄) amino alcohol component
(A₅) mercapto alcohol component
(A₆) monoifunctional hexafluoropropene oxide component
(A₇) difunctional hexafluoropropene oxide component
(A₈) carbonyl component
(A₉) monoffunctional polyalkylene glycol component
(A₁₀) monofunctional polyoxyalkylenamine component
(A₁₁) triazine component
(A₁₂) hydroxycarboxylic acid component
(A₁₃) NCN component
(A₁₄) polyfunctional polyalkylene glycol component
(A₁₅) polyfunctional polyoxyalkylenamine component
(A₁₆) (per)fluoroalkylalkanecarboxylic acid component
(A₁₇) (un)saturated fatty alcohol component
(A₁₈) (un)saturated fatty amine component
(A₁₉) (un)saturated fatty acid component
(A₂₀) epoxide component
(A₂₁) (un)saturated triglyceride component
(A₂₂) hydroxyl- and epoxy-functional (un)saturated triglyceride component
(A₂₃) (per)fluoroalkylalkylene oxide component
(A₂₄) hydroxy-functional epoxide component
(A₂₅) hydroxy-functional oxetane component
(A₂₆) cyclopropane component
(A₂₇) cyclobutane component
(A₂₈) hydroxy-functional lactone component
(A₂₉) fluorine-modified (meth)acrylate component
(A₃₀) latent curing component
(A₃₁) (per)fluoroalkylalkylene isocyanate component
(A₃₂) (per)fluoroalkylalkanecarboxylic acid derivative component
(A₃₃) polyhedral oligomeric polysilasesquioxane component
(A₃₄) alkylene 1-oxide component
(B) polyol component
(B₁) low molecular mass polyol component
(B₂) hydrophobically modified low molecular mass polyol component
(B₃) anionically modifiable and/or cafionically modifiable polyol component
(B₄) nonionically hydrophilic polymeric polyol component
(B₅) high molecular mass (polymeric) polyol component
(C) polyisocyanate component
(C₁) difunctional polyisocyanate component
(C₂) polyisocyanate component with functionality of three or more
(C₃) polyisocyanate component modified with uretdione groups
(C₄) polyisocyanate component modified with sodium sulfonate groups
(C₅) polyisocyanate component modified with unsaturated groups
(C₆) polyisocyanate component modified with ester groups
(D) neutralizing component
(E) (polymeric) chain extender and/or chain terminator component
(F) reactive nanoparticle component
(G) solvent component
(H) catalyst component
(I) water
(J) formulating component
(II) curing component

1. A functionalized polyurethane resin comprising
100.0 to 100.1 parts by weight of a binder component (I), composed of fluorine-modified, anionically and/or nonionically and/or cationically stabilized oligourethane or polyurethane dispersions or solutions, having a polymer-bonded fluorine content of 0.01% to 10% by weight, a molecular mass of 10 000 to 1 000 000 daltons, and 0% to 25% by weight of free amino groups and/or 0% to 25% by weight of free hydroxyl groups, with the following synthesis components:
(i) 0.3 to 7.5 parts by weight of a fluorine-modified (polymeric) hydrophobicizing and oleophobicizing component (A) having a polymer-bonded fluorine content of 0.5% to 90% by weight, two or more amino and/or hydroxyl and/or mercapto groups that are reactive toward isocyanate groups, or two or more isocyanato groups that are reactive toward hydroxyl groups, and a molecular mass of 250 to 25 000 daltons, composed of
(1) reaction products, having two or more hydroxyl groups, of 5% to 95% by weight of a (per)fluoroalkyl alcohol component (A₁) and/or of a (per)fluoroalkylalkylenamine component (A₂), composed of perfluoroalkyl alcohols having terminal methylene groups (hydrocarbon spacers) of the general formula
CF₃—(CF₂)ₓ—(CH₂)_{y}—O-A_{z}-H
and/or
CR₃—(CR₂)ₓ—(CH₂)_{y}—O-A_{z}-H
in which R=independently of one another H, F, CF₃
and/or
hexafluoropropene oxide (HFPO) oligomer alcohols of the general formula
CF₃—CF₂—CF₂—[O—CF(CF₃)—CF₂]ₓ—O—CF(CF₃)—(CH₂)_{y}—O-A_{z}-H
in which x=3-20, y=1-6, z=0-100,
A=CRⁱRⁱⁱCRⁱⁱⁱR^{iv}—O or (CRⁱRⁱⁱ)ₐ—O or CO—(CRⁱRⁱⁱ)_{b}—O, Rⁱ, Rⁱⁱ, Rⁱⁱⁱ, R^{iv}=independently of one another H, alkyl, cycloalkyl, aryl, any organic radical having 1-25 C atoms; a, b=3-5, the polyalkylene oxide structural unit A_{z} comprising homopolymers, copolymers or block copolymers of any desired alkylene oxides, or comprising polyoxyalkylene glycols or comprising polylactones,
and/or a fluorine-modified macromonomer or telechelic component (A₃) having a polymer-bonded fluorine content of 1% to 99% by weight and a molecular mass of 100 to 10 000 daltons, comprising, terminally and/or laterally and/or intrachenally in the side chain and/or main chain, the structural elements
—(CF₂—CF₂)ₓ—
and/or
—(CR₂—CR₂)ₓ—
and/or
—[CF₂—CF(CF₃)—O]ₓ—
and/or
—(CR₂—CR—O)ₓ—
having in each case one or more reactive (cyclo)aliphatic and/or aromatic hydroxyl groups and/or primary and/or secondary amino groups and/or mercapto groups, 75% to 5% by weight of a difunctional polyisocyanate component (C₁) having two or more (cyclo)aliphatic and/or aromatic isocyanate groups of like or different reactivity, and 75% to 5% by weight of an amino alcohol component (A₄) having a (cyclo)aliphatic and/or aromatic, primary or secondary amino group and one or more (cyclo)aliphatic and/or aromatic hydroxyl groups, and/or of a mercapto alcohol component (A₅) having a (cyclo)aliphatic and/or aromatic mercapto group and one or more (cyclo)aliphatic and/or aromatic hydroxyl groups, the reaction in the case of diisocyanates having been carried out preferably in a molar ratio of 1:1:1 in any desired way, and the reaction products having the general formula
(A_{1/2/3})-(C₁)-(A_{4/5})
with (A_{1/2/3})=deprotonated components (A₁) and/or (A₂) and/or (A₃), (A_{4/5})=deprotonated components (A₄) and/or (A₅), and (C₁)=protonated component (C₁),
and/or
(2) reaction products, having two or more hydroxyl groups, of 5% to 95% by weight of a monofunctional hexafluoropropene oxide component (A₆), composed of monofunctional hexafluoropropene oxide oligomers of the general formula
CF₃—CF₂—CF₂—O—(CF(CF₃)—CF₂—O)ₘ—CF(CF₃)—COR¹
in which m=1-20, R¹═F, OH, OMe, OEt
and 95% to 5% by weight of an amino alcohol component (A₄) and/or of a mercapto alcohol component (A₅), elimination of HR¹ having produced an adduct of the general formula
(A₆)-(A_{4/5})
in which (A₆)=carbonyl radical of component (A₆)
and the reaction having been carried out preferably in a molar ratio of 1:1 in any desired way,
and/or
(3) reaction products, having two or more hydroxyl groups, of 5% to 95% by weight of a difunctional hexafluoropropene oxide component (A₇), composed of difunctional hexafluoropropene oxide oligomers of the general formula
R¹OC—CF(CF₃)—(O—CF₂—CF(CF₃))ₙ—O—(CF₂)ₒ—O—(CF(CF₃)—CF₂—O)ₙ—CF(CF₃)—COR¹
in which n=1-10, o=2-6
and 95% to 5% by weight of an amino alcohol component (A₄) and/or of a mercapto alcohol component (A₅), elimination of HR¹ having produced an adduct of the general formula
(A_{4/5})-(A₇)-(A_{4/5})
in which (A₇)=carbonyl radical of component (A₇)
and the reaction having been carried out preferably in a molar ratio of 1:2 in any desired way,
and/or
(4) reaction products, having two or more hydroxyl groups, of 5% to 95% by weight of a (per)fluoroalkyl alcohol component (A₁) and/or of a (per)fluoroalkylalkylenamine component (A₂) and/or of a fluorine-modified macromonomer or telechelic component (A₃), 75% to 5% by weight of a carbonyl component (A₈) of the general formula
X—CO—Y
in which X, Y═F, Cl, Br, I, CCl₃, R², OR², R²=alkyl, cycloalkyl, aryl, any organic radical having 1-25 C atoms, 0-10 N atoms, and 0-10 O atoms
and 75% to 5% by weight of an amino alcohol component (A₄) and/or of a mercapto alcohol component (A₅), elimination of HX and/or HY in the first stage having produced an adduct of the general formula
(A_{1/2/3})-CO—Y and/or X—CO-(A_{1/2/3})
and/or
(A_{4/5})-CO—Y and/or X—CO-(A_{4/5})
and elimination of HX and/or HY in the second stage having produced an adduct of the general formula
(A_{1/2/3})-CO-(A_{4/5})
and the reaction having been carried out preferably in a molar ratio of 1:1:1 in any desired way,
or
reaction products of 5% to 95% by weight of a pre-prepared adduct of the general formula
(A_{1/2/3})-CO—Y and/or X—CO-(A_{1/2/3})
and 95% to 5% by weight of an amino alcohol component (A₄) and/or of a mercapto alcohol component (A₅), elimination of HX and/or HY having produced an adduct of the general formula
(A_{1/2/3})-CO-(A_{4/5})
and the reaction having been carried out preferably in a molar ratio of 1:1 in any desired way,
or
reaction products of 5% to 95% by weight of a pre-prepared adduct of the general formula
(A_{4/5})-CO—Y and/or X—CO-(A_{4/5})
and 95% to 5% by weight of a (per)fluoroalkyl alcohol component (A₁) and/or of a (per)fluoroalkylalkylenamine component (A₂) and/or of a fluorine-modified macromonomer or telechelic component (A₃), elimination of HX and/or HY having produced an adduct of the general formula
(A_{1/2/3})-CO-(A_{4/5})
and the reaction having been carried out preferably in a molar ratio of 1:1 in any desired way,
and/or
(5) reaction products, having two or more hydroxyl groups, of 5% to 95% by weight of a (per)fluoroalkyl alcohol component (A₁) and/or of a (per)fluoroalkylalkylenamine component (A₂) and/or of a fluorine-modified macromonomer or telechelic component (A₃), 75% to 5% by weight of an amino alcohol component (A₄) and/or of a mercapto alcohol component (A₅), and 75% to 5% by weight of a polyisocyanate component (C₂) having a functionality of three or more, the reaction in the case of triisocyanates having been carried out preferably in a molar ratio of 2:1:1 or 1:2:1 in any desired way,
and/or
(6) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a monofunctional polyalkylene glycol component (A₉) and/or of a monofunctional polyoxyalkylenamine component (A₁₀), composed of monohydroxy-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula
R³—O-A_{z′}-H
in which z′=5-150, R³=alkyl, cycloalkyl, aryl, any organic radical having 1-25 C atoms
and/or
monoamino-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula
R³—O-A_{z′-1}-CRⁱRⁱⁱ—CRⁱⁱⁱR^{iv}—NH₂
and 50% to 5% by weight of a polyisocyanate component (C₂) having a functionality of three or more, the reaction in the case of triisocyanates having been carried out preferably in a molar ratio of 1:1:1:1 in any desired way,
and/or
(7) reaction products, having two or more hydroxyl groups, of 5% to 95% by weight of a (per)fluoroalkyl alcohol component (A₁) and/or of a (per)fluoroalkylalkylenamine component (A₂) and/or of a fluorine-modified macromonomer or telechelic component (A₃), 75% to 5% by weight of an amino alcohol component (A₄) and/or of a mercapto alcohol component (A₅), and 75% to 5% by weight of a triazine component (A₁₁), composed of cyanuric chloride or 2,4,6-trichloro-1,3,5-triazine, the reaction having been carried out preferably in a molar ratio of 2:1:1 or 1:2:1 in any desired way,
and/or
(8) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a monofunctional polyalkylene glycol component (A₉) and/or of a monofunctional polyoxyalkylenamine component (A₁₀), and 50% to 5% by weight of a triazine component (A₁₁), composed of cyanuric chloride or 2,4,6-trichloro-1,3,5-triazine, the reaction having been carried out preferably in a molar ratio of 1:1:1:1 in any desired way,
and/or
(9) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a hydroxycarboxylic acid component (A₁₂), composed of a monohydroxycarboxylic acid and/or of a dihydroxycarboxylic acid having one and/or two polyisocyanate-reactive hydroxyl group(s) and a polyisocyanate-inert carboxyl group, and 50% to 5% by weight of a polyisocyanate component (C₂) having a functionality of three or more, the reaction in the case of triisocyanates having been carried out preferably in a molar ratio of 1:1:1:1 in any desired way,
and/or
(10) reaction products, having two or more hydroxyl groups, of 5% to 75% by weight of a (per)fluoroalkyl alcohol component (A) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of an NCN component (A₃), composed of cyanamide having a polyisocyanate-reactive and NH-acidic amino group, and 50% to 5% by weight of a polyisocyanate component (C₂) having a functionality of three or more, the reaction in the case of triisocyanates having been carried out preferably in a molar ratio of 1:1:1:1 in any desired way,
and/or
(11) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a hydroxycarboxylic acid component (Al₂), composed of a monohydroxycarboxylic acid and/or of a dihydroxycarboxylic acid having one and/or two polyisocyanate-reactive hydroxyl group(s) and a polyisocyanate-inert carboxyl group, and 50% to 5% by weight of a triazine component (A₁₁), composed of cyanuric chloride or 2,4,6-trichloro-1,3,5-triazine, the reaction having been carried out preferably in the molar ratio of 1:1:1:1 in any desired way,
and/or
(12) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of an NCN component (A₁₂), composed of cyanamide having a polyisocyanate-reactive and NH-acidic amino group, and 50% to 5% by weight of a triazine component (A₁₁), composed of cyanuric chloride or 2,4,6-trichloro-1,3,5-triazine, the reaction having been carried out preferably in a molar ratio of 1:1:1:1 in any desired way,
and/or
(13) reaction products, having two or more hydroxyl groups, of 5% to 75% by weight of a (per)fluoroalkyl alcohol component (A₁) and/or of a (per)fluoroalkylalkylenamine component (A₂) and/or of a fluorine-modified macromonomer or telechelic component (A₃), 50% to 5% by weight of an amino alcohol component (A₄) and/or of a mercapto alcohol component (A₅), 50% to 5% by weight of a low molecular mass polyol component (B₁) and/or of a hydrophobically modified low molecular mass polyol component (B₂) of an anionically modifiable and/or cationically modifiable polyol component (B₃) and/or of a nonionically hydrophilic, polymeric polyol component (B₄) and/or of a high molecular mass (polymeric) polyol component (B₅), and 50% to 5% by weight of a difunctional polyisocyanate component (C₁), the reaction having been carried out preferably in a molar ratio of 1:1:1:2 in any desired way, and the reaction products having the general formula
(A_{1/2/3})-(C₁)—(B_{1/2/3/4/5})—(C₁)-(A_{4/5})
in which (B_{1/2/3/4/5})=deprotonated components (B₁) and/or (B₂) and/or (B₃) and/or (B₄) and/or (B₅),
and/or
(14) reaction products, having two or more hydroxyl groups, of 5% to 75% by weight of a (per)fluoroalkyl alcohol component (A₁) and/or of a (per)fluoroalkylalkylenamine component (A₂) and/or of a macromonomer or telechelic component (A₃), 50% to 5% by weight of an amino alcohol component (A₄) and/or of a mercapto alcohol component (A₅), 50% to 5% by weight of a polyfunctional polyalkylene glycol component (A₁₄) and/or of a polyfunctional polyoxyalkylenamine component (A₁₅), composed of polyhydroxy-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula
R⁴(—O-A_{z′}-H)_{z″}
in which z″=2-6, R⁴=alkyl, cycloalkyl, aryl, any organic radical having 1-25 C atoms
and/or
polyamino-functional polyethylene glycols and/or poly(ethylene glycol-block-polyalkylene glycol) and/or poly(ethylene glycol-co-polyalkylene glycol) and/or poly(ethylene glycol-ran-polyalkylene glycol) with 25% to 99% by weight of ethylene oxide, and 0% to 74% by weight of a further alkylene oxide having 3 to 25 C atoms, of the general formula
R⁴(—O-A_{z′-1}—CRⁱRⁱⁱ—CRⁱⁱⁱR^{iv}—NH₂)_{z″}
and 50% to 5% by weight of a difunctional polyisocyanate component (C₁), the reaction in the case of difunctional polyalkylene glycols and/or polyoxyalkylenamines having been carried out preferably in a molar ratio of 1:1:1:2 in any desired way, and the reaction products having the general formula
(A_{1/2/3})-(C₁)-(A_{14/15})-(C₁)-(A_{4/5})
in which (A_{14/15})=deprotonated components (A₁₄) and/or (A₁₅)
and/or
(15) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃) and/or of a hexafluoropropene oxide component (A₆) with R¹═OH and/or of a hexafluoropropene oxide component (A₇) with R¹═OH and/or of a (per)fluoroalkylalkanecarboxylic acid component (A₁₆) of the general formula
CF₃—(CF₂)ₓ—(CH₂)_{y}—COOH
and/or
CR₃—(CR₂)ₓ—(CH₂)_{y}—COOH,
75% to 5% by weight of an amino alcohol component (A₄) and/or of a mercapto alcohol component (A₅) of a fatty alcohol component (A₁₇) having one or more hydroxyl groups, and/or of an (un)saturated fatty amine component (A₁₈) having one or more amino groups, and/or and/or of a fatty acid component (A₁₉) having one or more carboxyl groups, and 75% to 5% by weight of an epoxide component (A₂₀) having two or more epoxide groups, the reaction having been carried out preferably in a molar ratio of 1:1:1 in any desired way, and the reaction products having the general formula
(A_{1/2/3/6/7/16})-CH₂—CH(OH)—R⁵—CH(OH)—CH₂-A_{4/5/17/18/19})
and/or
HO—CH₂—CH((A_{1/2/3/6/7/16})—R⁵—CH((A_{4/5/17/18/19}))—CH₂—OH
and/or
(A_{1/2/3/6/7/16})—CH₂—CH(OH)—R⁵—CH((A_{4/5/17/18/19})—CH₂—OH
and/or
HO—CH₂—CH((A_{1/2/3/6/7}))-R⁵—CH(OH)—CH₂-(A_{4/5/17/18/19})
in which (A_{1/2/3/6/7/16})=deprotonated components (A₆) and/or (A₇) and/or (A₁₆), (A_{4/5/17/18/19})=deprotonated components (A₁₇) and/or (A₁₈) and/or (A₁₉), R⁵=alkyl, cycloalkyl, aryl, any organic radical having 2-50 C atoms and 0-25 O atoms and 0-25 N atoms,
and/or
(16) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a polyisocyanate component (C₃) modified with uretdione groups, and 75% to 5% by weight of an amino alcohol component (A₄) and/or of a mercapto alcohol component (A₅), the reaction having been carried out preferably in a molar ratio of 2:1.2 in any desired way,
and/or
(17) reaction products, having two or more isocyanate groups, of 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a polyisocyanate component (C₂) having a functionality of three or more, the reaction having been carried out preferably in a molar ratio of 1:1 in any desired way,
and/or
(18) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of an amino alcohol component (A₄) and/or of a mercapto alcohol component (A₅), and 75% to 5% by weight of a polyisocyanate component (C₄) modified with sodium sulfonate groups, the reaction having been carried out preferably in a molar ratio of 1:1:1 in any desired way,
and/or
(19) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a monoisocyanate component (C₅) modified with unsaturated groups, and 75% to 5% by weight of an amino alcohol component (A₄) and/or of a mercapto alcohol component (A₅), the reaction having been carried out preferably in a molar ratio of 1:1:1 in any desired way,
and/or
(20) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a monoisocyanate component (C₆) modified with ester groups, and 75% to 5% by weight of an amino alcohol component (A₄) and/or of a mercapto alcohol component (A₅), the reaction having been carried out preferably in a molar ratio of 1:1:1 in any desired way,
and/or
(21) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a difunctional polyisocyanate component (C₁), 75% to 5% by weight of a hydroxy-functional (un)saturated triglyceride component (A₂₁) having two or more hydroxyl groups, the reaction having been carried out preferably in a molar ratio of 1:1:1 in any desired way,
and/or
(22) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a hydroxy- and epoxy-functional (un)saturated triglyceride component (A₂₂) having one or more hydroxyl groups and/or one or more epoxy groups, the reaction having been carried out preferably in a molar ratio of 1:1 in any desired way,
and/or
(23) reaction products, having two or more hydroxyl groups, of 5% to 95% by weight of a (per)fluoroalkylalkylene oxide component (A₂₃) of the general formula
CF₃—CF₂)ₓ—(CH₂)_{y}—CHOCH₂
and/or
CR₃—(CR₂)ₓ—(CH₂)_{y}—CHOCH₂
and/or
CR₃—(CR₂)ₓ—(CH₂)_{y}—O—CH₂—CHOCH₂
and 95% to 5% by weight of an amino alcohol component (A₄) and/or of a mercapto alcohol component (A₅), the reaction having been carried out preferably in a molar ratio of 1:1 in any desired way,
and/or
(24) reaction products, having two or more hydroxyl groups, of 5% to 95% by weight of a (per)fluoroalkylalkylene oxide component (A₂₃) and 95% to 5% by weight of a chain extender or chain terminator component (E), the reaction in the case of monoamines with a primary amino group having been carried out preferably in a molar ratio of 2:1, in the case of diamines with two primary amino groups, preferably in a molar ratio of 4:1, in the case of diamines with a primary and a secondary amino group, preferably in a molar ratio of 3:1, and, in the case of diamines with a primary and a secondary amino group, preferably in a molar ratio of 2:1, in any desired way,
and/or
(25) reaction products, having two or more hydroxyl groups, of 5% to 95% by weight of a (per)fluoroalkylalkylene oxide component (A₂₃), 75% to 5% by weight of a difunctional polyisocyanate component (C₁), and 75% to 5% by weight of an amino alcohol component (A₄) and/or of a mercapto alcohol component (A₅), with oxazolidone structures having been formed, and the reaction having been carried out preferably in a molar ratio of 1:1:1 in any desired way,
and/or
(26) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a hydroxy-functional epoxide component (A₂₄) having one or more hydroxyl groups and/or one or more epoxy groups, and/or of a hydroxy-functional oxetane component (A₂₅) having one or more hydroxyl groups and/or one or more oxetane groups, the reaction having been carried out preferably in a molar ratio of 1:1 in any desired way,
and/or
(27) reaction products, having two or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃) and 95% to 5% by weight of a hydroxy-functional cyclopropane component (A₂₆) having one or more hydroxyl groups and/or one or more epoxy groups, and/or of a hydroxy-functional cyclobutane component (A₂₇) having one or more hydroxyl groups and/or one or more oxetane groups, the reaction having been carried out preferably in a molar ratio of 1:1 in any desired way,
and/or
(28) reaction products, having two or more hydroxyl groups, of 5% to 75% by weight of a (per)fluoroalkyl alcohol component (A₁) and/or of a (per)fluoroalkylalkylenamine component (A₂) and/or of a macromonomer or telechelic component (A₃), 50% to 5% by weight of a difunctional polyisocyanate component (C₁), 50% to 5% by weight of a hydroxy-functional lactone component (A₂₈), and 50% to 5% by weight of an amino alcohol component (A₄) and/or of a mercapto alcohol component (A₅), the reaction having been carried out preferably in a molar ratio of 1:1:1:1 in any desired way,
and/or
(29) reaction products, having two or more hydroxyl groups, of 5% to 95% by weight of a fluorine-modified (meth)acrylate component (A₂₉) and 95% to 5% by weight of an amino alcohol component (A₄) and/or of a mercapto alcohol component (A₅), the reaction having been carried out preferably in a molar ratio of 1:1 in any desired way,
and/or
(30) reaction products, having one or more primary and/or secondary amino groups and/or one or more hydroxyl groups, of 5% to 95% by weight of a (per)fluoroalkyl alcohol component (A₁) and/or of a (per)fluoroalkylalkylenamine component (A₂) and/or of a macromonomer or telechelic component (A₃), 75% to 5% by weight of a latent curing component (A₃₀) having a primary or secondary amino groups reactive toward isocyanate groups, or having a hydroxyl groups reactive toward isocyanate groups and having one or more hydroxyl groups and/or primary and/or secondary amino groups that are blocked and/or latently reactive toward isocyanate groups, and 75% to 5% by weight of water, first of all components (A₁) and/or (A₂) and/or (A₃) and (A₃₀) having been reacted in the first stage, the adduct from the first stage and the water having been reacted in the second stage, and any cleavage products liberated having been removed in the third stage, and the reaction having been carried out preferably in a molar ratio of 1:1:1 in any desired way,
and/or
(31) reaction products, having two or more hydroxyl groups, of 5% to 95% by weight of a (per)fluoroalkylalkylene isocyanate component (A₃₁) of the general formula
CF₃—(CF₂)ₓ—(CH₂)_{y}—NCO
and/or
CR₃—(CR₂)ₓ—(CH₂)_{y}—NCO
and 95% to 5% by weight of an amino alcohol component (A₄) and/or of a mercapto alcohol component (A₅), an adduct of the general formula
(A₃₁)-(A_{4/5})
in which (A₃₁)=protonated component (A₃₁)
having been obtained and the reaction having been carried out preferably in a molar ratio of 1:1 in any desired way,
and/or
(32) reaction products, having two or more hydroxyl groups, of 5% to 95% by weight of a (per)fluoroalkylalkanecarboxylic acid derivative component (A₃₂) of the general formula
CF₃—(CF₂)ₓ—(CH₂)_{y}—COR⁶
and/or
CR₃—(CR₂)ₓ—(CH₂)_{y}—COR₆
with R⁶=Cl, OMe, OEt
and 95% to 5% by weight of an amino alcohol component (A₄) and/or of a mercapto alcohol component (A₅), elimination of HR⁶ having produced an adduct of the general formula
(A₃₂)-(A_{4/5})
in which (A₃₂)=carbonyl radical of component (A₃₂)
and the reaction having been carried out preferably in a molar ratio of 1:1 in any desired way,
and/or
(33) reaction products according to variants (1), (5), (6), (9), (10), (13), (14), (16)-(22), the (per)fluoroalkyl alcohol component (A₁) and/or the (per)fluoroalkylalkylenamine component (A₂) and/or the macromonomer or telechelic component (A₃) having been replaced by the (per)fluoroalkylalkanecarboxylic acid component (A₃₂), and amide structures having been obtained, with elimination of CO₂,
and/or
(34) alkoxylated reaction products according to variants (1) to (16) and (18) to (33) having two or more hydroxyl groups, the alkoxylated reaction products having the general formula
(U)-(A_{z′}-H)_{z″}
in which (U)=deprotonated reaction products (1) to (16) and (18) to (33),
and/or
(35) a polyhedral oligomeric polysilasesquioxane component (A₃₃) having one or more amino and/or hydroxyl and/or isocyanato and/or mercapto groups and one or more perfluoroalkyl groups of the general formula
(R⁷ᵤR⁸ᵥR⁹_{w}SiO_{1.5})ₚ
in which 0<u<1, 0<v<1, 0w<1, u+v+w=1, p=4, 6, 8, 10, 12, and R⁷, R⁸, R⁹=independently of one another any inorganic and/or organic and optionally polymeric radical having 1-250 C atoms and 1-50 N and/or 0-50 O and/or 3-100 F and/or 0-50 Si and/or 0-50 S atoms,
(ii) 0.1 to 2.5 parts by weight of at least one low molecular mass polyol component (B₁) having two or more hydroxyl groups that are reactive toward isocyanate groups, and having a molecular mass of 62 to 499 daltons,
(iii) 0 to 2.5 parts by weight of at least one hydrophobically modified low molecular mass polyol component (B₂) having two or more hydroxyl groups that are reactive toward isocyanate groups, and having a molecular mass of 118 to 750 daltons, comprising, in the main chain and/or side chain, the structural elements
—(CH₂)ₖ— with k≧8,
(iv) 0 to 2.5 parts by weight of at least one anionically modifiable and/or cationically modifiable polyol component (B₃) having one or more inert carboxylic and/or phosphonic and/or sulfonic acid groups, which by means of bases can be converted partly or fully into carboxylate and/or phosphonate and/or sulfonate groups or are already present in the form of carboxylate and/or phosphonate and/or sulfonate groups, and/or having one or more tertiary amino groups, which by means of acids can be converted into ammonium groups or are already present in the form of ammonium groups, and having two or more hydroxyl groups that are reactive toward isocyanate groups, and a molecular mass of 104 to 499 daltons,
(v) 0.1 to 2.5 parts by weight of at least one nonionically hydrophilic polymeric polyol component (B₄) having two or more hydroxyl groups that are reactive toward isocyanate groups, and a molecular mass of 500 to 5000 daltons,
(vi) 1.0 to 25.0 parts by weight of at least one high molecular mass (polymeric) polyol component (B₅) having one or more hydroxyl groups that are reactive toward isocyanate groups, and a molecular mass of 500 to 10 000 daltons,
(vii) 1.0 to 25.0 parts by weight of at least one polyisocyanate component (C), composed of a polyisocyanate and/or polyisocyanate derivative and/or polyisocyanate homologs having two or more reactive (cyclo)aliphatic and/or aromatic isocyanate groups and a molecular mass of 100 to 5000 daltons,
(viii) 0.1 to 2.5 parts by weight of at least one neutralizing component (D), composed of an inorganic and/or organic base and/or acid,
(ix) 0.1 to 2.5 parts by weight of at least one (polymeric) chain extender and/or chain terminator component (E) having one or more primary and/or secondary (cyclo)aliphatic and/or aromatic amino groups that are reactive toward isocyanate groups, and/or having one or more hydroxyl groups that are reactive toward isocyanate groups, and a molecular mass of 60 to 5000 daltons,
(x) 0 to 2.5 parts by weight of at least one reactive nanoparticle component (F), composed of inorganic and/or organic nanoparticles or nanocomposites in the form of primary particles and/or aggregates and/or agglomerates, the nanoparticles being optionally hydrophobicized and/or doped and/or coated and surface-modified with reactive amino and/or hydroxyl and/or mercapto and/or isocyanato and/or epoxy and/or methacryloyl and/or silane groups of the general formula —Si(OR¹)_{3-x′}R²_{x′},
(xi) 0 to 100 parts by weight of at least one solvent component (G), composed of a high-boiling and/or low-boiling organic solvent,
(xii) 0 to 0.1 part by weight of at least one catalyst component (H),
(xiii) 97.3 to 100.0 parts by weight of water (I),
0 to 50 parts by weight of at least one curing component (II), composed of a polyisocyanate and/or polyisocyanate derivative and/or polyisocyanate homolog having two or more reactive (cyclo)aliphatic and/or aromatic isocyanate groups or a carbodiimide crosslinker and a molecular mass of 100 to 5000 daltons, and 0 to 300.0 parts by weight of a formulating component (III).

2-62. (canceled)
